(19) United States
(12) Patent Application Publication
(10) Pub. No.: US 2003/0002046 A1
(43) Pub. Date: Jan. 2, 2003

(54) Compound asymmetric interferometric wavelength converter

(76) Inventors: Michael H. Myers, Poway, CA (US); Richard S. Johnston, Sammamish, WA (US); Charles David Melville, Issaquah, WA (US)

Correspondence Address: ALL OPTICAL NETWORKS, INC., 9440 CARROLL PARK DRIVE, SAN DIEGO, CA, 92121, US

(21) Appl. No.: 10/138,187

(22) Filed: May 3, 2002

Related U.S. Application Data
(60) Provisional application No. 60/294,198, filed on May 29, 2001.
(60) Provisional application No. 60/346,502, filed on Oct. 19, 2001.
(60) Provisional application No. 60/343,433, filed on Oct. 19, 2001.
(60) Provisional application No. 60/343,416, filed on Oct. 19, 2001.

(51) Int. Cl. G01C 19/64

(52) U.S. Cl. 356/459

(57) ABSTRACT

A compound asymmetric interferometric wavelength converter receives a photonic signal of a first wavelength and bandwidth, and outputs a photonic signal of a second, more stabilized, wavelength and bandwidth. The apparatus may be either propagating or co-propagating, and measures selected photonic signal parameters dynamically and uses this information for self-calibration and to optimize and control signal quality of the photonic output signal.

### RELATED APPLICATIONS

This application claims the benefit under Title 35, United States Code Section 119(e) of the following co-pending U.S. provisional application Nos. 60/294,198, filed May 29, 2001; 60/346,502 filed Oct. 19, 2001; 60/343,433 filed Oct. 19, 2001; 60/343,43 filed Oct. 19, 2001; and 60/343,416 Oct. 19, 2001.

### BACKGROUND

1. Field of the Invention

This present invention relates to communication networks, and more specifically to methods and apparatus for stabilization and control, dynamically, of photonic data spectra in order to narrow bandwidths and shift spectra for channels to be multiplexed or in other transmission systems.

2. Background

Legacy photonic data sources have a variability in optical spectra which often limits the number of channels that can be multiplexed on a single optical fiber for data communication. A set of channels may have spectra that overlap or that are excessively broad, and which are not suitable as a group for multiplexing. An individual signal from a legacy photonic source may have a distribution of wavelengths that is excessively broad and consequently limited in data carrying capacity for modern, narrow band equipment. In order to provide a drop-in apparatus for integrating modern narrow band signal carrying and handling devices with legacy equipment as either sender or receiver, various implementations of an optimized self-calibrating channel stabilizer are provided. Channel stabilizers may rely on information transfer mechanisms, signal directors, wavelength shifters, and such effects as cross-gain modulation, cross-phase modulation, four-wave mixing, difference frequency generation, and frequency chirp frequency-shift-keying (FSK) for their operation. Moreover, channel stabilizers may be used to implement multiplexers, or integrated into systems using conventional multiplexers.

Legacy sources of photonic signals are typically data modulated lasers, light emitting diodes, and the like. Traditionally, legacy photonic systems suffer from various limitations on the precision of the characteristic parameters for a given signal. For example, lasers often produce a broad spectral output of a light signal compared to its modulation bandwidth. In certain circumstances, lasers or other photonic sources may drift from one frequency to another over a comparatively broad range of frequencies.

Often, since light is electromagnetic radiation dependent upon the theories of quantum mechanics, the selection of a frequency of emission is actually a quantum event. Accordingly, frequencies may actually hop. Frequency hopping in a photonic source may also be a direct result of certain geometries or chemistries that produce substantially equivalent probability, desirability, or physical possibility for generation of signals at multiple frequencies. Accordingly, frequency hopping may exist, causing a requirement to observe, track, accommodate, or assign a comparatively large bandwidth to each signal or channel being relied upon.

Typically, a signal does not contain energy at a single frequency. A modulated signal must include several frequencies. Often, legacy photonic sources have comparatively large deviations from a main frequency intended, desired, or nominally rated for a particular device.

Wavelength stabilization or wavelength shifting is needed. According to technical experts writing in the photonic industry, semiconductor laser diodes exhibiting multi-mode behavior are not considered suitable for applications requiring extended distance of transmission, or for applications requiring wavelength (frequency) multiplexing. Moreover, some writers characterize attempts at wavelength conversion as being confined to the laboratory, having no known practical implementations in commercial products or systems.

The result of the variation in the actual spectral output of a legacy photonic source, when compared to the desired or nominal value, is excessive use of available wavelength (frequency) ranges (bandwidth) required to be allocated to a particular channel or line of data or inability to be wavelength multiplexed. Inefficient use of the available spectral capacity of a media such as fiber, results in spectral inefficiency. In order to improve the spectral efficiency, either more channel capacity is required, or replacement of old equipment with newer more precise equipment is required. Both options amount to expense, substantial expense.

One difficulty in interfacing a wide-variety of photonic equipment is the assignment of channel wavelengths and encoding techniques. Setup and configuration become problematic. An ability to automatically channelize either excessively broad or narrow spectral sources by changing the center wavelength of a photonic carrier to a given channel and possibly reducing the bandwidth, and then transparently pass the data encoded photonic stream across a network of photonic equipment without prior knowledge of the channel wavelengths and encoding techniques, would reduce the cost and complexity of deploying photonic equipment.

Another issue in photonic transmission systems is carrier wavelength variability due to component variability, temperature drift, system jitter and other factors. Carrier wavelength variability makes it difficult to pack channels densely onto a transmission medium without collisions occurring, especially when multiplexing channels from multiple sources. Typically, expensive, temperature-compensated, reference lasers or light sources are required to stabilize a photonic signal. Most state-of-the-art photonic transmission systems require conversion to the electronic domain followed by re-modulation of a light source and retransmission in order to eliminate any jitter introduced during transmission. An ability to compensate for wavelength variability of existing photonic streams without re-modulation and retransmission would increase the capacity and lower the cost of transmission, multiplexing and switching equipment.

Accordingly, telecommunication systems can become bandwidth limited. Moreover, typically, the actual photonic transmission medium (e.g. light fiber, etc.) can carry substantially more information than the equipment attached to each end can send or receive. Thus, the capacity of conventional fiber transmission systems could be substantially improved if the signal generation, signal management, multiplexing, demultiplexing, detection, etc. equipment could be improved to operate within a narrower, more reliable range (bandwidth) of wavelength and frequencies, while still maintaining the requisite signal quality.

One benefit to using the current carrier medium with a more finely subdivided data bandwidth is the substantial increase of useable information bandwidth an increase in the spectral efficiency, defined by bits per second per Hertz of frequency bandwidth.

The alternative is to lay more cable (fibers) in order to support more end equipment for sending and receiving signals.

Several difficulties arise from the incompatibility of receivers with either the carrier medium, or a legacy photonic source. For example, a legacy photonic source is extremely expensive to replace. Thus, a more modem receiving mechanism, capable of carrying more channels in a given range of frequencies, cannot benefit therefrom if the original sources of data do not support the narrower bandwidths.

Similarly, a modem transmitting device cannot interface with legacy receiving equipment if the receiving device cannot provide the precision to distinguish signals within their comparatively narrow bands. Meanwhile, legacy equipment may be incompatible with carriers in that one component mismatched with another (e.g. in capacity), wastes the capacity of the underutilized element. Meanwhile, the great expense remains for upgrading each successive bottleneck in the transmission and receiving processes.

Thus, in general, having a mismatch of legacy equipment whether sending devices or receiving devices, in combination with either a modem narrow band sender or receiver, in view of the capacity of installed carrier media, results in either wasted spectral capacity or expensive replacement of existing equipment. Not only must the transmitted signal be received, it must be of sufficient quality to allow correct interpretation at the receiving end. Measurement parameters commonly used to quantify photonic or optical signals at some point in the communication process include the bit error rate (BER) and the extinction ratio (ER). The bit error rate indicates the quality of the signal when it is received at its destination, while the extinction ratio is one indication of the depth of modulation at any power level and therefore of the efficiency of the carrier power in sending information. It is common to specify or require a minimum ER at the transmitter end of a signal path in order to predict the maximum path length for an acceptable BER at the receiver. The traditional methodology is to fix the ER at the factory or adjust it manually in the field. The traditional approach does not account for parameter changes due to component aging, drift, thermal, environmental, or other deviations. The result is an inability to effectively cope with deviations of consequence. What is missing from the prior art is a means to dynamically optimize, control, or compensate for changes in parameters that affect the signal quality through such factors as the ER or related indicators such as modulated output power (MOP) levels. The lack of control of system photonic power output factors, ER and MOP is a direct consequence of lack of control of the constituent components of the systems involved. Such constituent components include whichever subsystems influence or determine the final output power parameters. Some modern systems have tighter (narrower) bandwidth requirements than traditional equipment, but use of such requires complete system substitution with its accompanying expense, and does not allow for interfacing effectively with legacy systems having looser specifications. In some instances the upgrade to more recent system technology may require replacing the connecting link (fiber) between source and destination. Such replacement can be prohibitively expensive. Hence the need for cost-effective control means which are compatible with existing installed systems.

What is needed is a mechanism for providing narrowing of bandwidth requirements while still maintaining adequate signal quality. This would best be accomplished if such a device could “drop-in” its modem, narrow-bandwidth capabilities within legacy networks. Two problems must be addressed and resolved to obtain a satisfactory solution: First, data stabilization must occur to narrow the requisite photonic bandwidth, and second, modulated signal power and quality must be maintained at levels sufficient to keep bit error rates of each data stream at an acceptable level.

### BRIEF SUMMARY AND OBJECTS OF THE INVENTION

The foregoing difficulties are overcome by channel stabilization utilizing dynamic optimization and self-calibration in accordance with the invention. In certain embodiments of an apparatus and method in accordance with the present invention, information may be transferred from one or more signals to an output signal that is stabilized to a reference signal. Various photonic devices may be used to accomplish this end. Photonic amplifiers may provide amplification, preferentially in a single direction, suppressing amplification in an opposite direction. Nonlinear gain or loss mechanisms may be employed to effect information transfer from one carrier to another.

Specific devices selected may rely on nonlinear media involving gas, dye, liquids, semiconductors, crystalline materials, polymers, semiconductor optical amplifiers, saturable absorbers, nonlinear gain or loss media, variable refractive index material or the like to provide the disparate amplification properties. For example, an amplifier having finite gain, when provided a continuous wave signal in one direction, will amplify the signal. A signal in the opposite direction, when its level reaches the reversing level of the device loses energy from the process of amplification, causing reduced output.

Such a process provides an inverting function having a comparatively wide, frequency band pass for a modulated input, while transferring information in an inverted form to the frequency of a continuous wave narrow bandwidth reference signal. Since the reference signal is available for use by other local photonic circuitry, the output may be wavelength locked to the external photonic circuitry.

Optimization and self-calibration are accomplished by measuring selected photonic signal parameters dynamically and extracting signal quality information therefrom, which is then used to optimize and control signal quality of the photonic output signal.

Applications for such an apparatus may include interfacing optical signals, such as those in the fiber of a legacy transmission system, in order to match to localized photonic circuitry in a transmitter or receiver. Provisioning and other processes that require allocation of frequencies and powers may benefit from the transfer of information from one wavelength to another.

The invention provides the means and methodology to dynamically optimize and control modulated output power (MOP), extinction ratio (ER), and concomitantly improve the noise figure determined by the relative values of the signal-to-noise ratio (SNR) of the input signal (SNRin)relative to that of the output signal-to-noise ratio (SNRout). The noise figure (NF) equals the ratio SNRin/SNRout. Such control, exercised in even a sub-optimal way enables prolonged utilization and increased bandwidth functionality for legacy or other broadband, or less stable sources and receivers. The invention provides adaptive optimization of the MOP and ER utilizing such information transfer mechanisms as cross-gain modulation (XGM) and cross-phase modulation (XPM), providing increased stability and output signal quality thereto. The invention makes possible dynamic optimization, control, and self-calibration of data stabilizers having non-interferometric, symmetric interferometric, asymmetric interferometric, and compound asymmetric interferometric hardware configurations. While enabling means to optimize the requisite phase and amplitude in interferometric hardware configurations, the invention concomitantly facilitates improved performance in the ER, MOP, and SNR, signal quality parameters. In the process, the invention overcomes the limitation in the prior art created by manually fixed extinction ratios and the like and is capable of compensating for device deficiencies resulting from aging, drift, and hardware deviations and the like. Thus, the invention provides improved narrow band performance to otherwise broad-banded and insufficiently stable, drifting systems while maintaining adequate signal quality of the photonic output signal in the process.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a telecommunications system relying on a dynamically optimized photonic channel stabilized sender and receiver in accordance with the invention;

FIG. 2 is a schematic block diagram of one embodiment of a multiplexing and demultiplexing telecommunications system relying on a photonic channel stabilization system in accordance with the invention;

FIG. 3 is a schematic block diagram of a telecommunications system relying on a dynamically optimized photonic channel stabilized sender in accordance with the invention;

FIG. 4 is a schematic block diagram of one embodiment of a channel stabilizer;

FIG. 5 is a schematic block diagram of one embodiment of a channel stabilizer showing details of one embodiment of a power stabilizer in accordance with the invention;

FIG. 6 is a schematic block diagram of one embodiment of an information-transfer apparatus of the co-propagating type;

FIG. 7 is a schematic block diagram of one embodiment of an information-transfer apparatus of the counter-propagating type;

FIG. 8 is a schematic block diagram of one embodiment of a data stabilizer of a non-interferometric type in accordance with the invention;

FIG. 9 is a schematic block diagram of an alternate embodiment of a data stabilizer of a non-interferometric type employing dynamic optimization control in accordance with the invention;

FIG. 10 is a schematic block diagram of an alternate embodiment of a data stabilizer of the Michelson interferometric type employing dynamic optimization control in accordance with the invention;

FIG. 10A is a schematic diagram of photonic coupler representations utilized in various embodiments in accordance with the present invention;

FIG. 11 is a schematic block diagram of an alternate embodiment of a data stabilizer of the co-propagating symmetric Mach Zehnder interferometric type employing dynamic optimization control in accordance with the invention;

FIG. 12 is a schematic block diagram of an alternate embodiment of a data stabilizer of the counter-propagating symmetric Mach Zehnder interferometric type employing dynamic optimization control in accordance with the invention;

FIG. 13 is a schematic block diagram of an alternate embodiment of a data stabilizer of the co-propagating Mach Zehnder interferometric type employing polarization discrimination and dynamic optimization control in accordance with the invention;

FIG. 14 is a schematic block diagram of an alternate embodiment of a data stabilizer of the counter-propagating Mach Zehnder interferometric type identifying potential asymmetries in media-gain, path-length, and four coupler sites while utilizing dynamic optimization control in accordance with the invention;

FIG. 15 is a schematic block diagram of an alternate embodiment of a data stabilizer of the counter-propagating Mach Zehnder interferometric type employing complimentary coupler asymmetry and dynamic optimization control in accordance with the invention;

FIG. 16 is a schematic block diagram of an alternate embodiment of a data stabilizer of the counter-propagating Mach Zehnder interferometric type employing media gain asymmetry and dynamic optimization control in accordance with the invention;

FIG. 17 is a schematic block diagram of an alternate embodiment of a data stabilizer of the co-propagating Mach Zehnder interferometric type employing media-gain asymmetry, path-length asymmetry, and dynamic optimization control in accordance with the invention;

FIG. 18 is a schematic representation of a co-propagating Mach Zehnder interferometer employing path-length asymmetry;

FIG. 19 is a graph of two examples of phase difference versus frequency resulting from using an interferometer employing path-length asymmetry;

FIG. 20 is a schematic block diagram of an alternate embodiment of a data stabilizer of the co-propagating compound asymmetry Mach Zehnder interferometric type employing media gain asymmetry, path-length asymmetry, coupler asymmetry, and dynamic optimization control of the non-linear media, the tunable reference source, and the power stabilizer, in accordance with the invention;

FIG. 21 is a schematic block diagram of an alternate embodiment of a data stabilizer of the Mach Zehnder interferometric type employing media gain asymmetry, path-length asymmetry, coupler asymmetry, lens-matching of the mode field diameter of non-linear media to connecting photonic paths, and dynamic optimization control in accordance with the invention;

FIG. 22 is a schematic block diagram of an alternate embodiment of a data stabilizer of the Mach Zehnder interferometric type employing media gain asymmetry, path-length asymmetry, coupler asymmetry, lens-matching of the mode field diameter of the non-linear media to connecting photonic paths, and dynamic control in accordance with the invention;

FIG. 22A is a schematic block diagram of an alternate embodiment of a data stabilizer of the compound asymmetric counter-propagating Mach Zehnder interferometric type employing media gain asymmetry, path-length asymmetry, coupler asymmetry, and dynamic control in accordance with the invention;

FIG. 23 is a schematic block diagram of an alternate embodiment of a data stabilizer of the compound asymmetric Mach Zehnder interferometric type employing mechanical flexure capability for precision path-length compensation and dynamic control in accordance with the invention;

FIG. 24 is a schematic side view of hardware for securely mounting semiconductor optical amplifiers and precision photonic alignment with connecting photonic path links;

FIG. 25 is a schematic cross-sectional end view of hardware for securely mounting a semiconductor optical amplifier and precision photonic alignment with connecting photonic path links;

FIG. 26 is a schematic block diagram of one embodiment of a compensator used to extract photonic output signal information suitable for dynamic optimization and control in accordance with the invention;

FIG. 27 is a schematic block diagram of an alternate embodiment of a compensator used to extract photonic output signal information suitable for dynamic optimization and control in accordance with the invention;

FIG. 28 is a schematic block diagram of one embodiment of a photonic multiplexer of the coupler type;

FIG. 29 is a schematic block diagram of one embodiment of a photonic multiplexer of the arrayed waveguide type;

FIG. 30 is a schematic block diagram of one embodiment of a photonic multiplexer of the dielectric type;

FIG. 31 is a schematic block diagram of one embodiment of a photonic multiplexer of the circulator filter type;

FIG. 32 is a schematic block diagram of one embodiment of a photonic multiplexer of the circulator filter type having local electronic and remote photonic dynamic control paths;

FIG. 33 is a schematic block diagram of an embodiment of a photonic receiver unit consisting of a photonic demultiplexer-monitor assembly, a controller, and interconnecting information paths;

FIG. 34 is a schematic block diagram of one embodiment of a channel monitor unit constituting part of the control apparatus in accordance with the invention;

FIG. 35 is a schematic block diagram of one embodiment of a photonic demultiplexer of the coupler type;

FIG. 36 is a schematic block diagram of one embodiment of a photonic demultiplexer of the arrayed waveguide type;

FIG. 37 is a schematic block diagram of one embodiment of a photonic demultiplexer of the dielectric type;

FIG. 38 is a schematic block diagram of one embodiment of a photonic demultiplexer of the circulator filter type;

FIG. 39 is a schematic block diagram of one embodiment of a photonic demultiplexer of the circulator filter type having local electronic and remote photonic dynamic control paths;

FIG. 40 is a graph representing photonic output power signal fractions indicative of the modulated, unmodulated, and average parts thereof;

FIG. 41 is a table of required photonic output power parameters measured, calculated, or estimated as part of the dynamic optimization, control, and self-calibration in accordance with the invention;

FIG. 42 is a flow chart representative of one embodiment of the control methodology used to dynamically optimize desired photonic power parameters in accordance with the invention;

FIG. 43 is a flow chart representative of an alternate embodiment of the control methodology used to dynamically optimize desired photonic power parameters in accordance with the invention;

FIG. 44 is a graphical representation of the parameter space optimization search process for maximizing photonic modulated output power as a function of variations of SOA bias current and laser bias current in accordance with the invention.

### DETAILED DESCRIPTION OF THE PREFERRED EMBODIMENTS

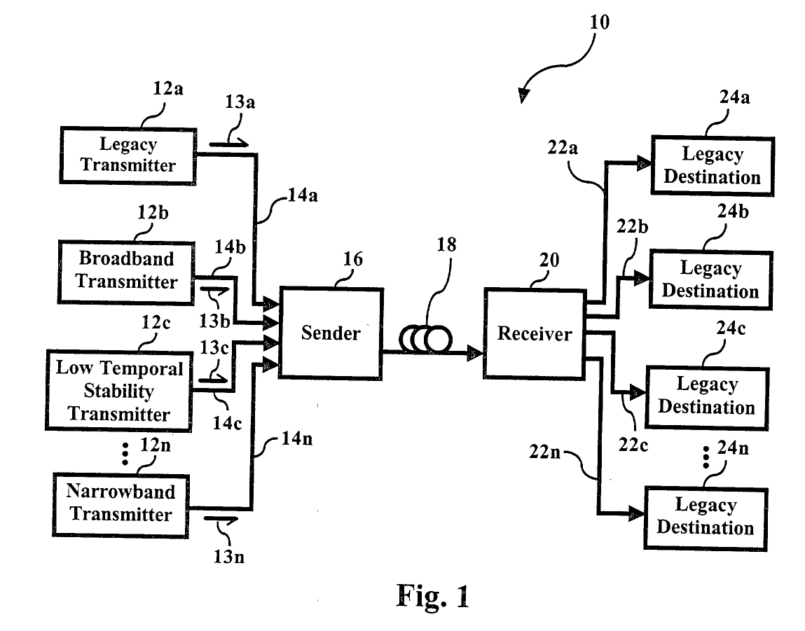

It will be readily understood that the components of the present invention, as generally described and illustrated in the figures herein, could be arranged and designed in a variety of different configurations. Thus, the following more detailed description of the embodiments of this system and method of the present invention, as represented in FIGS. 1 through 43, is not intended to limit the scope of the invention. The scope of the invention is as broad as claimed herein. The illustrations are merely representative of certain presently preferred embodiments of the invention. Those presently preferred embodiments of the invention would be best understood by reference to the drawings wherein like parts are designated by like numerals throughout.

Those of ordinary skill in the art will, of course, appreciate that various modifications to the details of the figures may easily be made without departing from the essential characteristics of the invention. Thus, the following description of the figures is intended only by way of example, and simply illustrates certain [presently] preferred embodiments consistent with the invention as claimed.

Referring to FIG. 1, A telecommunications apparatus 10 may include legacy photonic sources 12 providing output signals 13 of photonic data having a broad band wavelength spectrum of low temporal stability to photonic data line 14 which subsequently enters a sender of photonic data 16. The sender 16 stabilizes the legacy data in its wavelength and temporal characteristics and narrows the wavelength bandwidth used by each legacy source before multiplexing the photonic data signals in the wavelength domain and outputing the composite photonic data stream onto link 18. Link 18 carries the photonic data to receiver 20. The receiver 20 receives the multiplexed data, demultiplexes it in the wavelength domain, and directs the demultiplexed narrow band signals to their legacy destinations 24 over photonic data lines 22. The legacy sources 12 may be of various types. Typically, they may be broadband sources; sources which have a low temporal stability or other undesirable characteristics. The legacy signal broadbandedness and low stability precludes the transmission of multiple legacy channels over data link 18 without intervening apparatus. The invention described herein consists principally of elements 16 and 20 which are designed to receive the broadband legacy signals, stabilize the information content thereof, narrow the signal bandwidth required by each received signal, combine the information, and transmit the composite data down a single photonic link 18. Receiver 20 receives the composite data signal on data link 18, demultiplexes the data and distributes the information to legacy destinations 24 or other designated reception points of various types. The present invention can function in concert with narrow-band transmitters 12n. Such narrow-band sources are compatible with the invention, as are broadband sources 12a, 12b and 12c. Traditionally, the cost of running multiple fibers from legacy transmitters 12 to legacy destinations 24 is very expensive. A cost effective alternative is to insert sender 16 and receiver 20 capable of stabilizing the signals and making it possible to send multiple data channels from the legacy transmitters to the legacy destinations over a single fiber 18. FIG. 1 shows a single sender 16 and a single receiver 20. It should be noted that there will be a sender at each end and a receiver at each end, thus, resulting in a total of two fibers—one carrying information going each direction. The signal flow path of the present invention goes from legacy transmitters 12, through photonic data paths 14 to sender 16, through a legacy link 18 which may be a considerable distance, to receiver 20 and subsequently on through data lines 22 to legacy destinations 24. The signal flows through the invention all optically, without being converted to an electronic signal in the process.

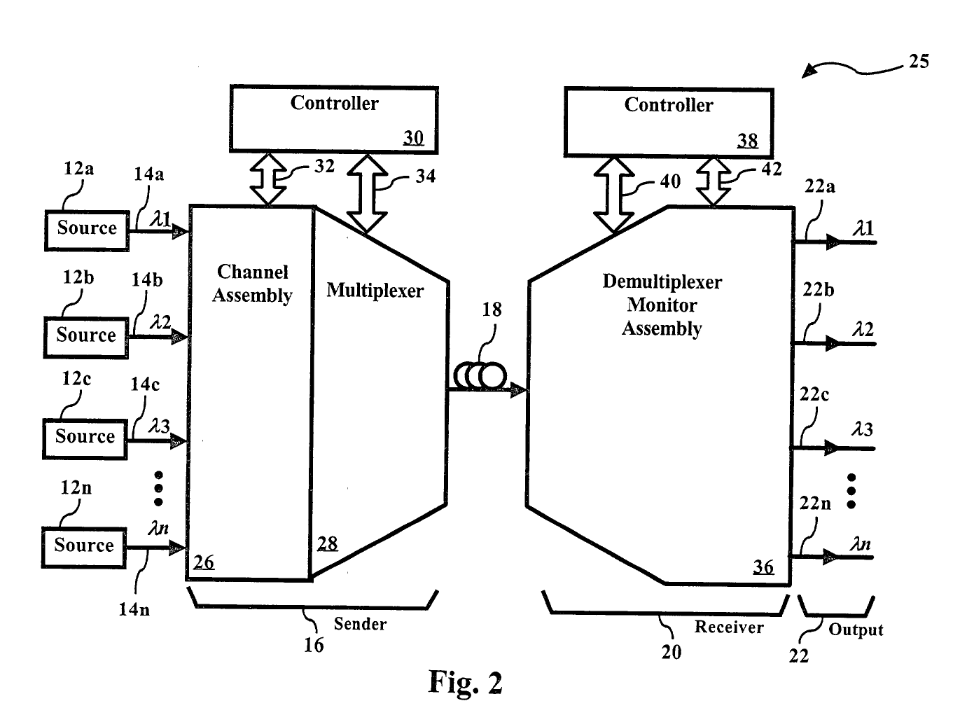

Referring to FIG. 2, the dynamic stabilization system 25 of the present invention receives photonic data input from photonic sources 12 over data paths 14 that connect into channel assembly 26. The channel assembly then passes its information through to the multiplexer 28 out through the photonic link 18. Channel assembly 26 and multiplexer 28 communicate with controller 30 over data lines 32 and 34, respectively which may carry both photonic and electronic monitoring and control information. Controller 30 serves as a master controller over all channel and multiplexing processes occurring in sender 16. The multiplexed data output on line 18 by sender 16 is transmitted to receiver assembly 36 which consists principally of a demultiplexer and monitor assembly with a controller 38 attached through links for photonic and electronic monitoring 40 and 42. The demultiplexer monitor assembly 36 outputs its demultiplexed data through photonic links 22. Controllers 30 and 38 on the sender and receiver ends of data link 18, respectively, function to coordinate the operations of the channel assembly and the multiplexer operation at both the sending end for controller 30 and at the receiving end for controller 38.

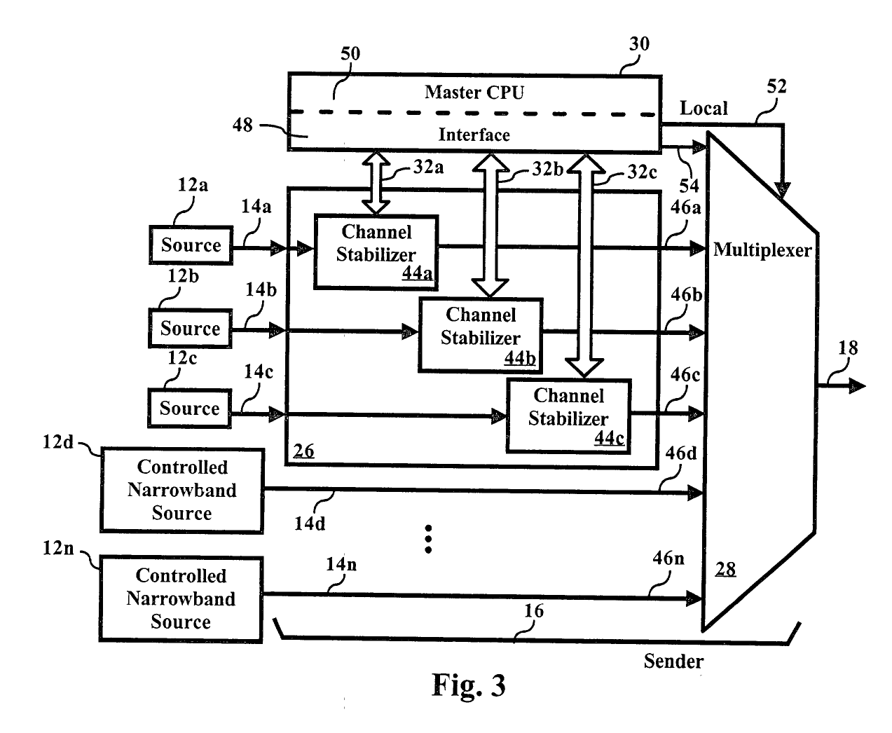

Referring to FIG. 3, an alternative embodiment of the present invention shows legacy sources 12a, 12b and 12c providing photonic input data on lines 14 to channel assembly 26. Additional controlled, narrow band sources 12d-12n provide photonic data on lines 14d-14n directly to multiplexer 28. In this embodiment, the controlled narrow band sources 12d-12n must be strictly controlled in both power output level and frequency. Direct input of narrow-band data on lines 14d-14n has limitations relative to the more general capability of data entered through links 14a, 14b and 14c, into channel assembly 26. Channel assembly 26 is composed of channel stabilizers 24, one for each channel of photonic data that comes in through data paths 14. Each channel stabilizer 44 communicates with master controller 30, which is composed of two parts; interface 48 and master central-processor-unit (CPU) 50. Channel stabilizers 44 communicate through interface 48 with master CPU 50 to effect appropriate monitoring and control of the apparatus. The data output of each photonic channel stabilizer 44 traverses data path 46 to multiplexer 28. Multiplexer 28 receives photonic and electronic control information from master controller 30 in addition to photonic data received through paths 46 from stabilizers 44. Controller 30 is a master controller that in one embodiment oversees local multiplexer operations through control line 52 and oversees remote operations by means of photonic control information sent over path 54. Local control line 52 enables controller 30 to exert direct control over multiplexer 28 operations, such as frequency control, stability, and other such matters. Remote link 54, going from the master controller 30 to multiplexer 28, functions to allow photonic input to the multiplexer which will subsequently be transmitted out link 18 as control information to the remote location or locations wherever they may be. Photonic data comes in on lines 14 to sender 16 which information, after being appropriately stabilized, narrowed in spectral bandwidth, and otherwise regulated, is sent out photonic link 18. In addition to photonic data on lines 14, control information may also be transmitted from master controller 30 over photonic data path 54 and out through link 18 to receiver 20.

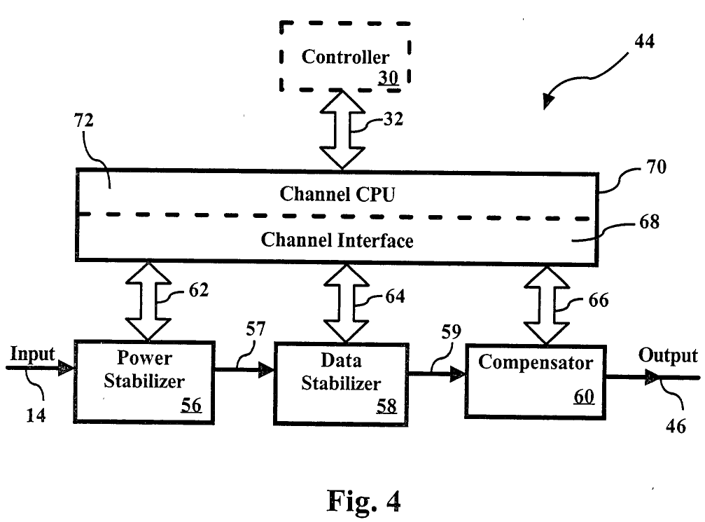

Referring to FIG. 4, channel stabilizer 44 receives photonic input data on lines 14 into power stabilizer 56. The power stabilizer 56 sends information and receives direction through data path 62 from channel processor 70, which is composed of channel interface 68 and channel CPU 72. Channel processor 70 communicates through link 32 with master controller 30. Signal output of power stabilizer 56 traverses link 57 to data stabilizer 58. Data stabilizer 58 receives photonic data over link 57 and communicates with channel processor 70 through link 64 both sending information and receiving direction from channel processor 70. The photonic output of data stabilizer 58 traverses photonic link 59 to compensator 60 wherein the photonic data is sampled. Compensator sends information through link 66 to channel processor 70 and provides photonic data output on data path 46 for multiplexing by apparatus of the present invention.

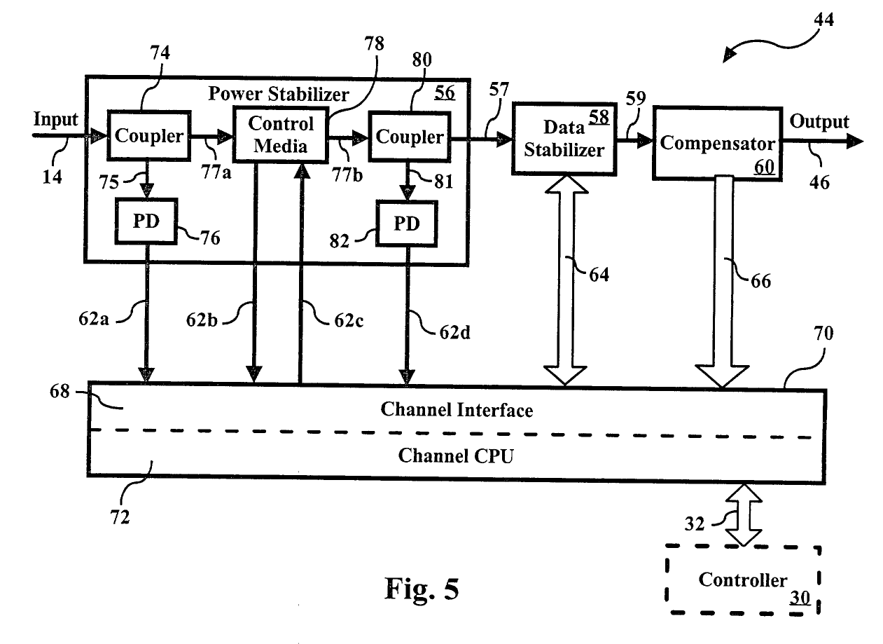

Referring to FIG. 5; power stabilizer 56 receives data from photonic input data path 14. Upon entering the power stabilizer, the photonic data encounters coupler 74, which samples a fraction of the total photonic power and diverts it through line 75 to photo detector 76, which subsequently sends signal 62a to channel interface 68 of channel processor 70. The major portion of the photonic input data 14 passes directly through coupler 74 and line 77a to control media 78. Control media 78 must have some means of having its photonic characteristics changed by external control ine 62c. Such control means include the input of control information form photonic, electronic, radiofrequency sources, and the like. In some embodiments control media itself may be a nonlinear device or material such as a polymer, a semiconductor optical amplifier (SOA), a polarizeable material, crystal, or doped material susceptible to external control. Other embodiments of control media 78 may utilize linear material as the active controllable media. Control media 78 is monitored by processor 70 through line 62b and receives direction from processor 70 through line 62c. After operating on the photonic data signal, control media 78 passes the photonic data signal out line 77b to coupler 80. Coupler 80 samples a portion of the photonic data signal received on line 77b output by control media 78 and passes the sampled information through link 81 to photo detector 82 and subsequently through line 62d to processor 70. The substantial portion of the photonic data signal that enters coupler 80 on line 77b is passed through to line 57 and out line 57 to data stabilizer 58 where it continues in the process of being optimized and stabilized as a part of the present invention. The power stabilizer 56 serves the function of stabilizing the power level of the input signal coming in line 14 so that the output signal 57 has a stable reference power level to be used for subsequent processing. Control is effected by sampling the input photonic data signal entering on line 14, sampling the photonic data signal output by power stabilizer 56 on line 57, and by receiving direction from external channel processor 70, in combination. The photonic data signal output by power stabilizer 56 on data path 57 enters data stabilizer 58.

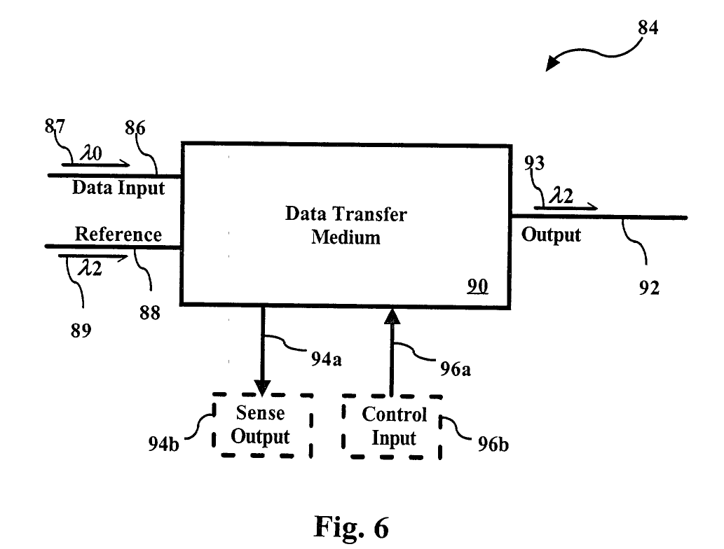

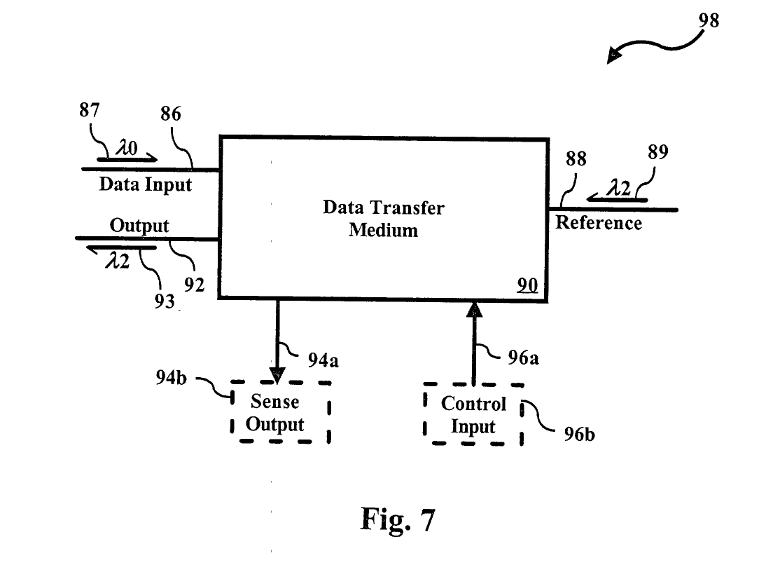

Subsequent FIGS. 6 through 27 refer to aspects in whole or in part of data stabilizer 58. A number of different embodiments are described. Notwithstanding, the number of embodiments of the data stabilizer 58 of the present invention, some aspects are ubiquitous therein. One such aspect is illustrated in greater detail in FIG. 6 and FIG. 7.

Referring to FIG. 6 and FIG. 7, nonlinear media 90 effects information transfer from the data input signal 87 characterized by wavelength λ0 and the reference signal 89 characterized by wavelength μ2. Reference signals such as 89 are sometimes referred to as “probe” signals in published literature dealing with wavelength converters. The term “reference” signal is used herein, as it is more functionally descriptive of what the component does. The transfer of information by the data transfer medium or nonlinear media may be effected using several different modes of operation, several of which techniques include, cross-amplitude modulation, or cross-gain modulation (XGM), cross-phase modulation (XPM), and four-wave mixing (FWM). All techniques are not equal. A single stage embodiment of data transfer medium 90 utilizing cross-gain modulation generally produces a photonic data output signal that is inverted in phase from the photonic input data signal. Data transfer embodiments incorporating two XGM stages in succession can provide a photonic output data signal that has the same phase as the photonic input data signal. Alternate embodiments employing cross-phase modulation can be adjusted to give either an inverted or a non-inverted output signal relative to the input signal. Some embodiments have advantages in frequency response. Some embodiments have advantages in details of the hardware implementation required, such as the length of interaction necessary to effect data transfer etc. In general, the data transfer medium 90 may operate in one or more of these modes to achieve the desired result of information transfer from one wavelength to another or from one signal path to another. Data transfer from one wavelength to another may be one objective, either by itself or in concert with other desired effects. Stabilization of the information such that the final output signal has a relatively narrow, stable spectrum, centered at a desired wavelength, a stable modulated output power of acceptable level, an acceptable extinction ratio (ER), and stable temporal characteristics, are objects of the present invention intimately associated with the operation of the data transfer medium employed.

Referring to FIG. 6, information transfer apparatus 84 of the co-propagating type contains non-linear media 90, also referred to as data transfer media 90, which enables the transfer of photonic information from one photonic data line at a first photonic wavelength to a second photonic data line at a second photonic wavelength. Photonic data line 86 brings photonic data 87 characterized by wavelength λ0 to nonlinear media 90. The photonic data signal 87 passes through nonlinear media 90 and is subsequently discarded. Reference signal 89 characterized by wavelength λ2 enters nonlinear media 90 on data line 88 and is modulated by the effect of the photonic data signal 87 on the nonlinear media 90. The modulated signal 89 exits the nonlinear media on data line 92 as the photonic output signal 93 characterized by wavelength λ2 and carrying the information content of signal 87. The present embodiment shows both the data signal 87 and the reference signal 89 traveling in the same direction while traversing nonlinear media 90 in what is termed a co-propagating configuration. In addition to the inputs and outputs of photonic information, the nonlinear media 90 may have, as optional elements, a sense output signal 94b, and a control input signal 96b. Sense output signal 94b is sent out on line 94a to be processed or managed elsewhere, and control input signal 96b input on line 96a provides control information to the nonlinear media and is used to modify characteristics of the nonlinear medium in some desirable manner. Sense output 94 and control input 96 are optional and may not be present in all embodiments involving nonlinear media 90.

Referring to FIG. 7, information transfer apparatus 98 of the counter-propagating type contains non-linear media 90, also referred to as data transfer media 90, which enables the transfer of photonic information from one photonic data line at a first wavelength to a second photonic data line at a second photonic wavelength. Photonic data line 86 brings photonic data 87 characterized by wavelength λ0 to non-linear media 90. The photonic data signal 87 passes through nonlinear media 90 and is subsequently discarded. Reference signal 89 characterized by wavelength λ2 enters nonlinear media 90 on data line 88 proppagating in a direction counter to that of photonic input data 87, and is modulated by the effect of photonic data signal 87 on the nonlinear media 90. The modulated signal 89 exits the nonlinear media on data line 92 as photonic output signal 93 characterized by wavelength λ2 and carrying the information content of signal 87. The present embodiment shows both the data signal 87 and the reference signal 89 traveling in opposite directions while traversing nonlinear media 90 in what is termed a counter-propagating configuration. In addition to the inputs and outputs of photonic information, the nonlinear media 90 may have, as optional elements, a sense output signal 94b, and a control input signal 96b. Sense output signal 94b is sent out on line 94a to be processed or managed elsewhere, and control input signal 96b input on line 96a provides control information to the nonlinear media and is used to modify characteristics of the nonlinear medium in some desirable manner. Sense output 94 and control input 96 are optional and may not be present in all embodiments involving nonlinear media 90. The output signal 93, on line 92 characterized by wavelength λ2 may be taken off wherever it is convenient and the representation as shown is one embodiment, but not the only one. The control input 96b and sense output 94b maintain their same functionality as previously described. The co-propagating configuration, schematically represented in FIG. 6 and the counter-propagating configuration, schematically represented in FIG. 7 show only the bare essentials of the nonlinear data transfer medium 90. Additional components such as wavelength filters, circulators, isolators and other such components common to the photonics industry may be required in order to separate the desired output signal 93 characterized by wavelength λ2 from other wavelength component signals such as the input signal 87 characterized by wavelength λ0. In the figures that follow, nonlinear media 90 occur frequently and in different embodiments. For clarity of discussion, some nonlinear media will be given distinct numbers even though they are the same type or class of media as illustrated by element 90. Distinct numbers are used for the purpose of discussion not necessarily because there is a difference of functionality. The nonlinear mechanism of any individual nonlinear media element 90 may consist of any of the following, or combinations thereof; a semiconductor optical amplifier, an organic polymer composition, an optical crystal, a material that possesses ferromagnetic properties, a waveguide filling material, a molecular, atomic, or ionic dopant in an otherwise photonically transmissive material, a saturable absorber, a lossy medium, a gain medium such as that used in a laser composition being a dye, semiconductor, doped glass, or other materials of a solid, crystalline, liquid, gas, gelatinous, semiconductor, fluorescent, or resistive constitution.

Referring again to FIG. 6 and FIG. 7, the sense output 94b may be one of a number of different types or combinations thereof. It can be a thermal sense signal, an electronic signal, a photonic signal, or any other such indicator of the status of nonlinear medium 90. Likewise, the control input 96b coming in through line 96 may be of a photonic, electronic, radio frequency (rf), thermal, or chemical nature. Input 96b may involve a modification to the refractive index or alteration of the photonic carrier lifetime of the nonlinear media 90 through the various energy means cited. Both the sense output 94b and the control input 96b may be direct or indirect regarding the photonic data signal passing through nonlinear media 90. “Direct” is interpreted to mean the energy input is photonic in nature. Indirect is interpreted to be use of any other form of energy, such as temperature, an electronic current bias to the various devices, an electronic voltage bias voltage, or the like. Direct and indirect signals may involve changes in parameters such as refractive index; polarization orientation, birefringence characteristics of the device utilizing some form of energy, photonic or otherwise. Changes effected in nonlinear media 90 by control inputs 96b may involve such parameters as refractive index, temperature, wavelength, attenuation, gain, optical path length or phase, device bandwidth or other such parameters. In an alternate embodiment, variations, biasing, and control of nonlinear media 90 may be effected by inputting a photonic control signal on the same photonic path used by the signal to be stabilized, either in a co-propagating or a counter-propagating manner. Such a control signal may be in addition to the reference signal and may be used to control the gain, attenuation, on-off status, switching characteristics, time constants of other parameters associated with nonlinear media 90.

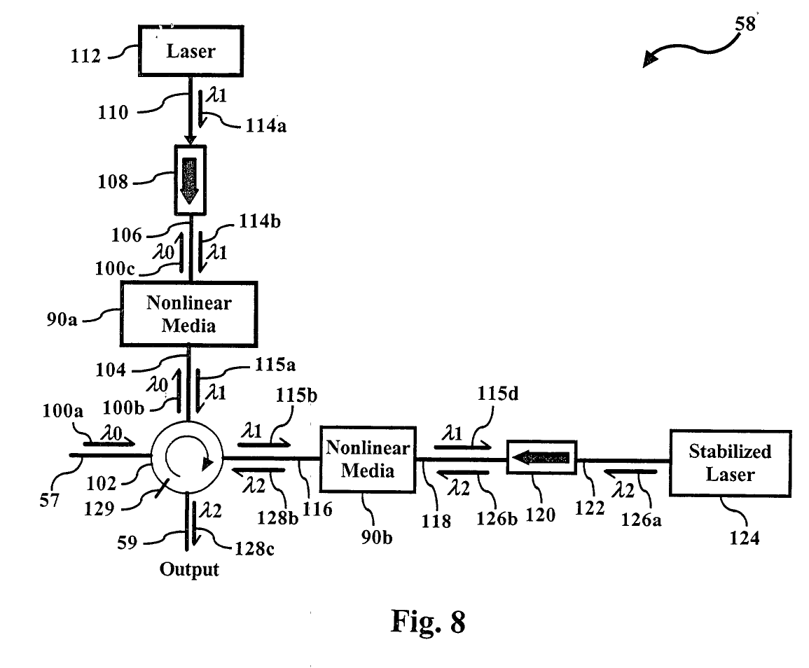

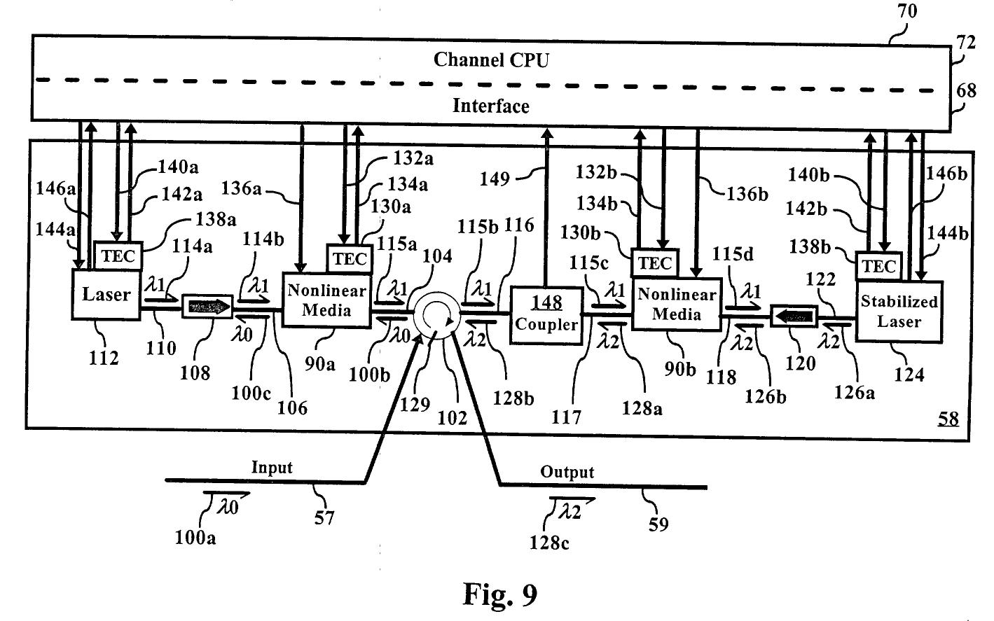

Referring to FIG. 8 and FIG. 9, embodiments of a data stabilizer 58 containing nonlinear media 90a and 90b are shown. Line 57 provides a data input path for photonic data 100a characterized by wavelength λ0 as it enters data stabilizer 58. The photonic data signal 100a enters circulator 102, which directs the signal onto line 104. The signal 100b continues to nonlinear media 90a through the media on to isolator 108 as photonic signal 100c where it is absorbed because it is flowing in a direction opposite to that of the isolator's transmission. The input line to isolator 110 comes from laser 112 that provides a reference signal 114a characterized by wavelength λ1. Reference signal 114a, passes into isolator 108, down line 106 as signal 114b to nonlinear media 90a where it is modulated in the nonlinear media by the counter-propagating photonic signal 100b. Modulated signal 114b becomes signal 115a upon exiting nonlinear media 90a on line 104. Signal 115a is characterized by wavelength λ1, but modulated with information content of photonic signal 100b. Photonic data signal 115a is inverted relative to input data signal 100a. Data signal 115a passes to circulator 102, and is directed onto line 116 as signal 115b and enters nonlinear media 90b. Signal 115d continues out of nonlinear medium 90b on line 118 until it encounters isolator 120, in which it is absorbed. Stabilized laser 124 outputs photonic reference signal 126a. Signal 126a travels on line 122 to isolator 120 and on to line 118 as signal 126b where it encounters nonlinear media 90b. The reference signal 126b is modulated in nonlinear media 90b by the interaction of the nonlinear media with photonic signal 115b. In nonlinear media 90b the information contained in photonic signal 115b characterized by wavelength λ1 is transferred to the photonic reference signal 126b characterized by wavelength λ2. Upon exiting nonlinear media 90b, signal 128b contains the information formerly carried at wavelength λ1 as it proceeds on line 116 to circulator 102 where it is directed out line 59 as signal 128c characterized by wavelength λ2. Photonic output data signal 128c has the same (non-inverted) phase sense as input data signal 100a. Any photonic signals coming up line 59 toward circulator 102 are diverted into stop 129 where they are absorbed and not allowed to pass.

Stabilized laser 124 may be a distributed feedback (“DFB”) laser or a wavelength locked narrow-band laser. Isolator 120 which is shown as a distinct component may sometimes be incorporated into laser 124. Because of the highly stable, highly isolated characteristics of the laser itself, isolator 120 may not be necessary. The same holds true for isolator 108. Depending on the type of laser 112, isolator 108 may not be necessary. In some embodiments, it may be needed and in others not. FIG. 8 shows a basic embodiment of data stabilizer 58 without showing control lines explicitly.

Referring to FIG. 9, one embodiment of data stabilizer 58 has control lines 132, 136, 140, 144, and sense or monitor lines 134, 142, 146, passing between channel processor 70 to effect monitoring and control of data stabilizer 58 through various means. Nonlinear media 90a, may use a thermal electric cooler 130a to help control operating characteristics of nonlinear media 90a. Thermal electric cooler 130a outputs information concerning its own status on line 134a to channel processor 70. In turn, thermal electric cooler 130a receives control information on line 132a from channel processor 70. In addition to thermal control exerted by thermal electric cooler 130a on nonlinear media 90a, a direct line 136a may exist going from channel processor 70 to nonlinear media 90a and may be used to exert control on nonlinear media 90a. Such control information on lines 136 may be electronic control of electronic bias levels as well as photonic control of photonic bias levels, as needed. Just as the nonlinear media 90 have control elements attached thereto sending and receiving information therefrom, so do lasers 112 and 124 have thermal electric coolers 138, which send sense signals 142 to channel processor 70, and receive control direction from the channel processor through lines 140. Additional parameter sensing for lasers 112 and 124 is output to channel processor 70 through lines 146 and additional control over lasers 112 and 124 is exerted by channel processor 70 on the lasers 112 and 124 by lines 144. The embodiment of the present invention shown in FIG. 9 contains additional coupler element 148 not shown in FIG. 8. Coupler 148 is located between circulator 102 and nonlinear media 90b to sample the photonic data signal traversing lines 116 and 117. Photonic data is sampled by coupler 148 and the sample signal sent on line 149 to channel processor 70 for monitoring and control purposes. By sensing such information, it is possible to maintain proper control of the operation and thus avoid overloading nonlinear media 90 and component burnout.

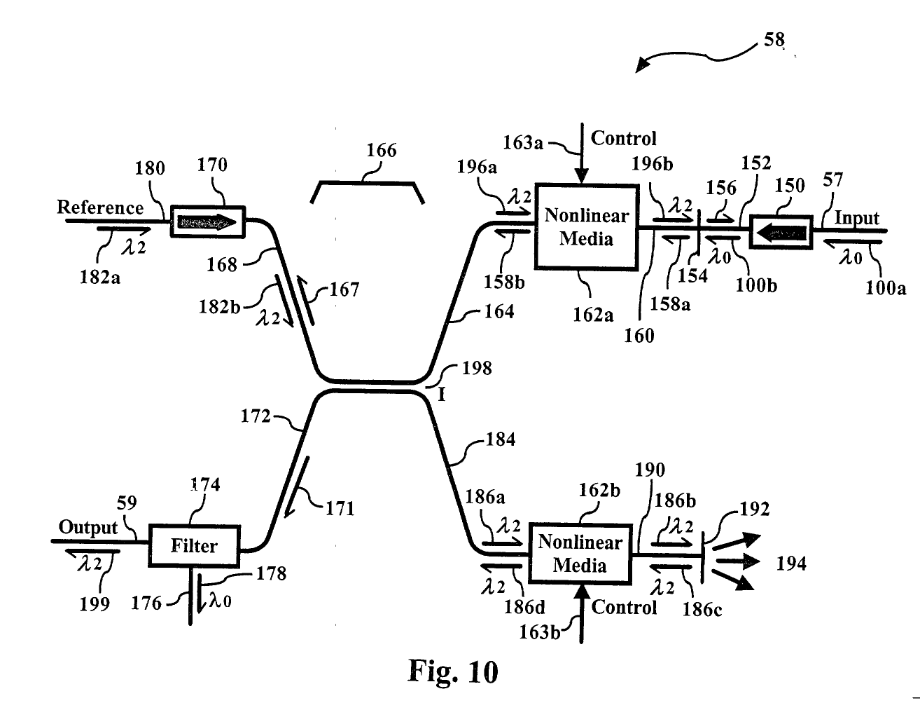

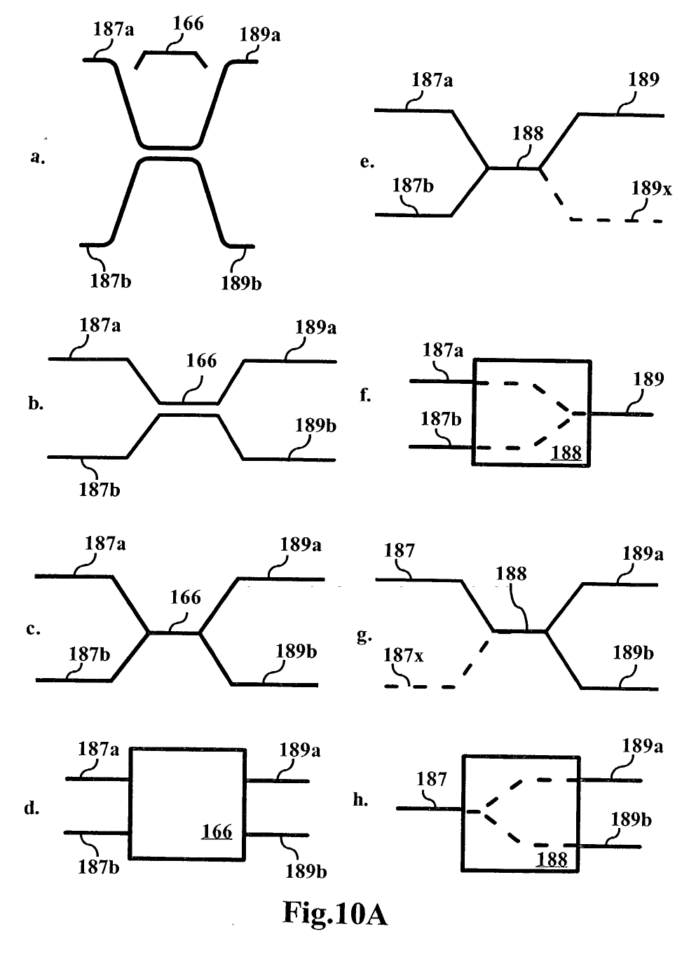

Referring to FIG. 10, data stabilizer 58 of the Michelson interferometer type receives photonic data signal 000a characterized by wavelength λ0 when it enters on line 57. Data signal 100 passes through isolator 150 onto line 152 and encounters partially reflecting surface 154 at which point a portion of signal 100b is reflected back to isolator 150 and is absorbed. The fractional portion of signal 100b that passes through surface 154 becomes signal 158a and continues on line 160 to nonlinear media 162. Nonlinear media 162 is of the type 90 discussed previously. Distinct numbers are used to avoid confusion in the discussion. Control line or lines 163 effect control of nonlinear media 162 under external direction such as from processors 70 or 38. Signal 158b exits nonlinear media 162 on line 164 and is split into two parts by coupler 166. A first part of signal 158b goes on line 168 and is absorbed by isolator 170, and a second part goes down line 172 until it is intercepted by filter 174 and output on line 176 as signal 178 characterized by wavelength λ0. Data stabilizer 58 depicted in FIG. 10 has multiple signals going multiple directions through it. Reference signal 182a characterized by wavelength λ2 enters stabilizer 58 on line 180, passes through isolator 170 to line 168, passes down line 168 as signal 182b to coupler 166 where it is split into two amplitude parts. Part one of signal 182b goes down line 184 as signal 186a enters nonlinear media 162b and passes out line 190 as signal 186b where it encounters surface 192. Surface 192 may be partially reflecting or totally reflecting, depending on the method of fabrication. In some embodiments surfaces 154 and 192 may be used for control purposes. The surfaces may be servo controlled to vary in such parameters as reflectivity, polarization orientation, absorption, phase, and the like. Phase changes can be used to switch or invert the sense of the final photonic output signal 199. Surface 154 and more particularly surface 192 may be used to advantage to compensate for media gain differences between nonlinear media 162a and 162b and to otherwise balance, switch, control, and optimize the circuit. Varying the polarization orientation or reflectivity of surface 192 provides an independent means of altering the signal 186c which feeds back on line 190 to eventually interact interferometrically at junction 198. Changes in any of the photonic parameters of signal 186c affect the interferometric interaction at junction 198 and consequently a changed photonic output signal will result. For embodiments in which surface 192 is partially reflecting, a portion of signal 186b passes through surface 192 and is emitted as radiation 194, which may subsequently be used for sampling or as waste. The second portion of signal 186b not transmitted through surface 192, is reflected back to nonlinear media 188 as signal 186c into the nonlinear media 162b. Signal 186c exits nonlinear media 162b as signal 186d, and proceeds up line 184 to coupler junction 166. The second portion of signal 182b that entered coupler 166 on line 168 and did not go down line 184, goes up line 164 as signal 196a, and passes through nonlinear media 162a wherein it is modulated with the information contained in counter propagating signal 158a. Signal 196a exits nonlinear media 162a on line 160 as signal 196b and proceeds until it encounters partially reflecting surface 154. A first part of signal 196b passes through surface 154 onto line 152 as part of signal 156 and is absorbed by isolator 150. A second part of signal 196b that is not transmitted through partially reflective surface 154 is reflected back on line 160 as part of signal 158a into nonlinear medium 162a. As signal 196 characterized by wavelength λ2 passes through nonlinear media 162a, it is modulated by signal 158a which contains a fractional portion of signal 100b characterized by wavelength λ0. Consequently, photonic information contained in signal 100b at wavelength λ0, is transferred to signal 158b by means of nonlinear media 162a. The modulated signal 158b exits from the nonlinear media and passes down line 164 to interferometric junction 198 where it interacts interferometrically with reflected signal 186d. Interferometric junction 198 is “interferometric” when two signals that are coherent relative to each other at the same wavelength encounter the junction simultaneously. Maximum interferometric interaction occurs when signals (1) Are spectrally coherent (the same wavelength), (2) Have the appropriate phase relationship, (a relative phase that is fixed, or at least varies relatively slowly), (3) Have the same polarization state (orientation), (4) Have the same amplitude, and (5) Are spatially coherent over an interaction surface or volume (overlapping in spatial extent in other than an orthogonal manner, so that interaction can occur). Thus, when unmodulated signal 186d characterized by wavelength λ2 enters the junction simultaneously with modulated signal 158b also characterized by wavelength λ2, but containing the information originally present in signal 100, an interferometric interaction occurs. Modulated signal 158b, after interacting interferometrically at interferometric junction 198, goes out the opposite side of coupler 166 as two fractional amplitude signals. A first fraction of the interferometric interaction may go down line 168 as a part of signal 167 and be absorbed in isolator 170 and a second fraction may travel down line 172 as a part of signal 171 until it encounters filter 174. Filter 174 separates the desired spectral signal fraction characterized by wavelength λ2 from the now superfluous signal characterized by wavelength λ0. The desired output signal characterized by wavelength λ2 is output on line 59 as signal 199. The undesired signal characterized by wavelength λ0 exits on line 176 as signal 178. The data stabilizer of the Michelson type shown in FIG. 10 might be interpreted to be a symmetric configuration. Although this is not necessarily the case, symmetry has some desirable features, but asymmetric combinations are also possible. An asymmetric combination would have dissimilar gain media where 162a and 162b are different or biased differently such that their operation characteristics are slightly different. That is one form of asymmetry. The photonic signal paths 164 and 184 may have different line lengths. The photonic signal paths 160 and 190 may have different lengths, which would yield an asymmetry in the coupler, in the interferometer. A third form of asymmetry can occur at the coupler 166. The coupler may be frequency sensitive where one frequency is passed, and another frequency is not. The coupler may be made so that it is a high-pass filter, a low-pass filter, or a band-pass filter. All of which characteristics may be used to adjust the nature of the coupling. The coupling and splitting ratio may not be 50/50. If may be such that information entering on one leg is not split 50/50 on the two outputs, but is split using some other power fraction ratio. Thus, there are several forms of asymmetry involving power splitting ratio, spectral characteristics, gain and phase characteristics of nonlinear media 162 and line lengths of the reflective lines 160 and 190. These forms of asymmetry may be used separately or in combination to accomplish the objectives of separating signals in a desirable manner. By incorporating filter characteristics in the coupler 166, the filter 174 may be unnecessary in some embodiments. Signal paths 160 and 190 may be of different lengths or of zero length.

Referring to FIG. 10A, specifically, and FIGS. 10-23 generally, four-port photonic directional coupler 166 shown with data stabilizer 58 in FIG. 10 may be illustrated in several equivalent forms. Four equivalent embodiments of coupler 166 are given in parts a, b, c, and d, of FIG. 10A. Connecting lines 187 and 189 provide photonic input and output functionality. A signal entering on line 187a is split into two fractional parts by coupler 166 and is output on lines 189a and 189b. If the splitting ratio is 1:1 or 50/50 as it is sometimes designated, the two fractional parts are equal in power amplitude and the coupler is commonly referred to as a 3 db (power) splitter or coupler. Other splitting ratios are also used. Four port couplers are perhaps the most common, but other numbers of ports are possible. Parts e, f, g, and h of FIG. 10A show examples of couplers having only three connecting ports. Paths 189x and 187x are unused and often not visible or available on the outside of a coupler 188. A signal entering port 187a of coupler 188 shown in part e of FIG. 10A will exit line 189 reduced in amplitude. The reduction in amplitude occurs even if port 189x is not accessible. The three port devices commonly available are ordinarily “four port devices with one port inaccessible”. Amplitude splitting occurs as if the fourth port were present

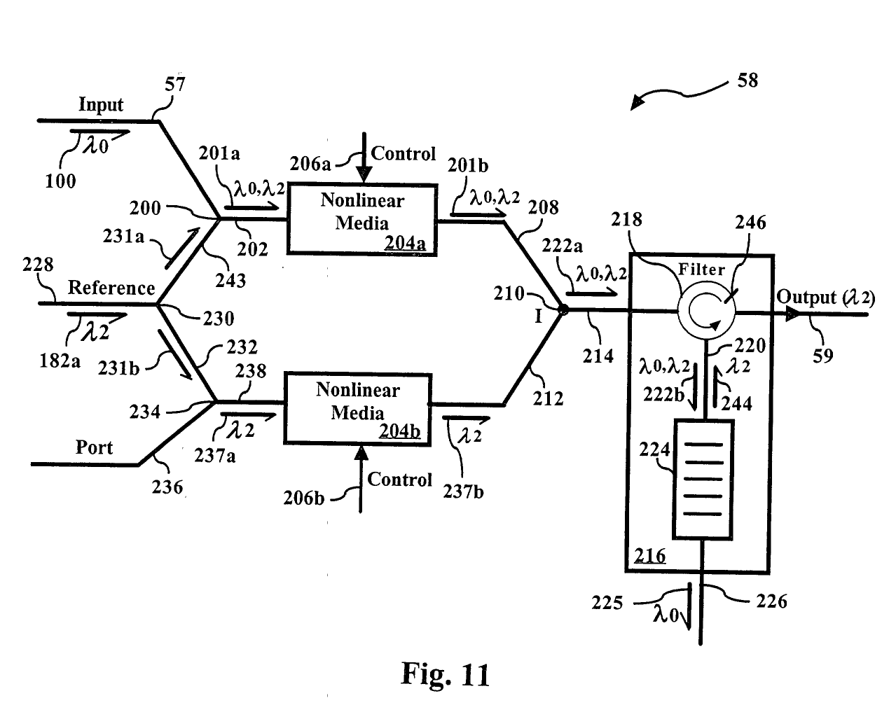

Referring to FIG. 11, specifically, while referring generally to FIGS. 10-23, data stabilizer 58 may be fabricated using a co-propagating Mach-Zehnder configuration. Embodiments having a co-propagating configuration may generally be altered to serve in a counter-propagating configuration, and visa versa. Concepts that apply to one type of propagation configuration often apply as well to the other. Photonic data signal 100 characterized by wavelength λ0 is input on line 57 and propagates to coupler junction 200 where it is split and consequently reduced in amplitude. The fractional portion of interest of input signal 100 goes down line 202 as part of signal 201 a and enters nonlinear media 204a whose operation is controlled by control line 206a. Photonic data signal 201 exits nonlinear media 204a on line 208 as signal 201b and propagates to interferometric junction 210 where the signal is again split and reduced in amplitude.

While data signal 100 characterized by wavelength λ0 is input on line 57 of the Mach-Zehnder configuration, reference signal 182a, characterized by wavelength λ2, is input on line 228 where it propagates to coupler junction 230 and is split into two parts, signals 231a and 231b, having reduced power amplitudes. Signal 231b goes down line 232 until it enters coupler junction 234. Junction 234 has one line 236 that may be used as a second input location or remain unused. A fractional portion of signal 231b exits junction 234 on line 238 as signal 237a and enters nonlinear media 204b controlled by control line 206b. Signal 237 exits nonlinear media 204b as signal 237b on line 212 and continues until it encounters interferometric junction 210. The portion of signal 182a that does not go down line 232 as signal 231b goes down line 243 as signal 231a to coupler junction 200 where its amplitude is reduced by the junction. Signal 201a which exits coupler junction 200 on line 202 is composed of two fractional parts. A first part arises from signal 100 characterized by wavelength λ0 and a second part arises from signal 231a characterized by wavelength λ2. The signal 201a travels down line 202 until it encounters nonlinear media 204a. The two fractional parts of signal 201a characterized by wavelengths λ0 and λ2, respectively, interact as co-propagating signals in nonlinear media 204a. The result is that the second signal at wavelength λ2 is modulated by the information contained on the first signal of wavelength λ0. The output from nonlinear media 204a exits on line 208 as signal 201b, composed of two parts, a part characterized by λ0 and the part of interest characterized by λ2. Signal 201b continues down line 208 until it encounters interferometric junction 210. At interferometric junction 210, signal 201b meets signal 237b. The fractional part of signal 201b characterized by wavelength λ2 is coherent with and interacts interferometrically with signal 237b which is also characterized by wavelength λ2. The two coherent components of signal information both at wavelength λ2 interact interferometrically such that the modulated information of interest continues down line 214 as a portion of signal 222a. Signal 222a also contains the fractional part of signal 201b characterized by wavelength λ0 which did not interact interferometrically at junction 210 because it had no coherent counterpart with which to interact. Signal 222a travels down line 214 to filter 216 and enters circulator 218 where it is directed out path 220 as signal 222b to filter 224. Filter 224 is a narrow band reflection filter that reflects a narrow band of wavelengths centered around λ2 and transmits all others. Consequently, the portion of signal 222b characterized by wavelength λ0 passes through filter and is output on line 226 as signal 225. The fraction of signal 222b characterized by wavelength λ2 is reflected back on line 220 as signal 244 where it reenters circulator 218, and is directed out line 59 where it is output at a wavelength λ2 with the information content of the original input signal 100. Circulator 218 has a stop 246 to prevent any information from entering on line 59.

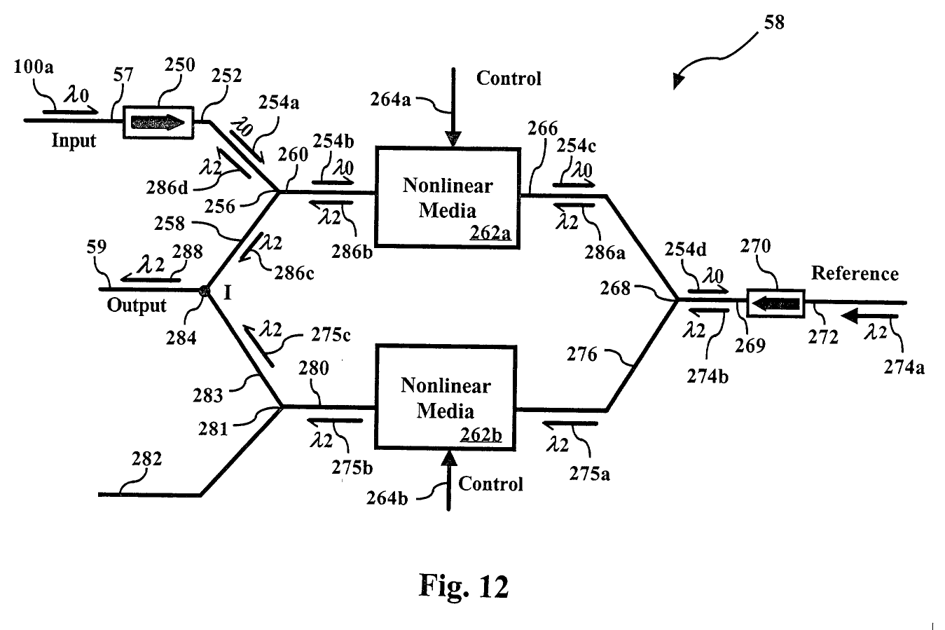

Referring to FIG. 12, an alternate embodiment of data stabilizer 58 of the counter-propagating Mach-Zehnder type is illustrated. Input data signal 100a characterized by wavelength λ0 enters on line 57, passes through isolator 250 on to line 252 as signal 254a and encounters coupler junction 256 where its amplitude is reduced. Signal 254 continues out coupler junction 256 as signal 254b to nonlinear media 262a controlled by control line 264a. Signal 254 exits nonlinear media 262a on line 266 as signal 254c, travels to coupler junction 268 where its amplitude, is reduced as it passes through and becomes signal 254d. Signal 254d passes down line 269 until it encounters isolator 270 where it is absorbed.

Reference signal 274a characterized by wavelength λ2 enters stabilizer 58 on line 272a traveling in a counter-propagating direction relative to input data signal 100 and passes through isolator 270 to line 269 and becomes signal 274b. Signal 274b continues on line 269 to coupler junction 268 where it is split into two parts, signals 275a and 286a, each of which is reduced in amplitude from the parent signal 274b. Signal 286a travels down line 266, enters nonlinear media 262a and is modulated by counter-propagating signal 254b. After being modulated in nonlinear media 262a signal 286a emerges as signal 286b on line 260. Signal 286b has the information content of signal 254b modulated on it. Signal 286b proceeds on line 260 to coupler junction 256 where its amplitude is split into two parts that become signals 286c and 286d. Signal 286d goes down line 252 and is absorbed by isolator 250. Signal 286c goes down line 258 and enters interferometric junction 284.

The other portion of signal 274b that was split off at coupler junction 268 proceeds down line 276 as signal 275a, and enters nonlinear media 262b controlled by control line or lines 264b. Signal 275a exits nonlinear media 262b as signal 275b onto line 280 and travels to coupler junction 281 where it is split into two amplitude fractions. A portion goes down line 282 which is generally unused but which may be used as an alternate port in some embodiments or for data sampling, measurement purposes, or other such things. In the present embodiment signals entering path 282 are unused. The other fraction of signal 275b that is split off at 281 proceeds down line 283 as signal 275c until it encounters interferometric junction 284. At interferometric junction 284 signals 286c and 275c both characterized by wavelength λ2 an origninating from the same reference signal 274a meet and interact interferometrically. Signals 275c and 286c are coherent signals having the same wavelength but containing different modulations. Signal 286c is modulated with information from signal 254b as it passed through nonlinear media 262. Signal 275c was operated on by nonlinear media 262b, but not modulated with any signal more than that contained in its parent reference signal 274c when it entered stabilizer 58 on line 272. The term “operated on” is used to mean one or more of the following: amplified, attenuated, unaltered in amplitude, shifted in phase as it passes through the nonlinear media. The interferometric interaction of signals 275c and 286c and at interferometric junction 284, results in output signal 288 characterized by wavelength λ2 exiting on line 59 as a modulated signal carrying the information content originally contained on input signal 110a, albeit in either a non-inverted or an inverted form. In the present embodiment photonic data signal 100a characterized by wavelength λ0 enters data stabilizer 58 on line 57. Reference signal 274a characterized by wavelength λ2 enters on line 272. At the conclusion of processing by stabilizer 58, output signal 288 characterized by a wavelength-stabilized, temporally-stabilized, relatively narrow band wavelength λ2 exits on line 59 carrying information that entered on signal 100a.

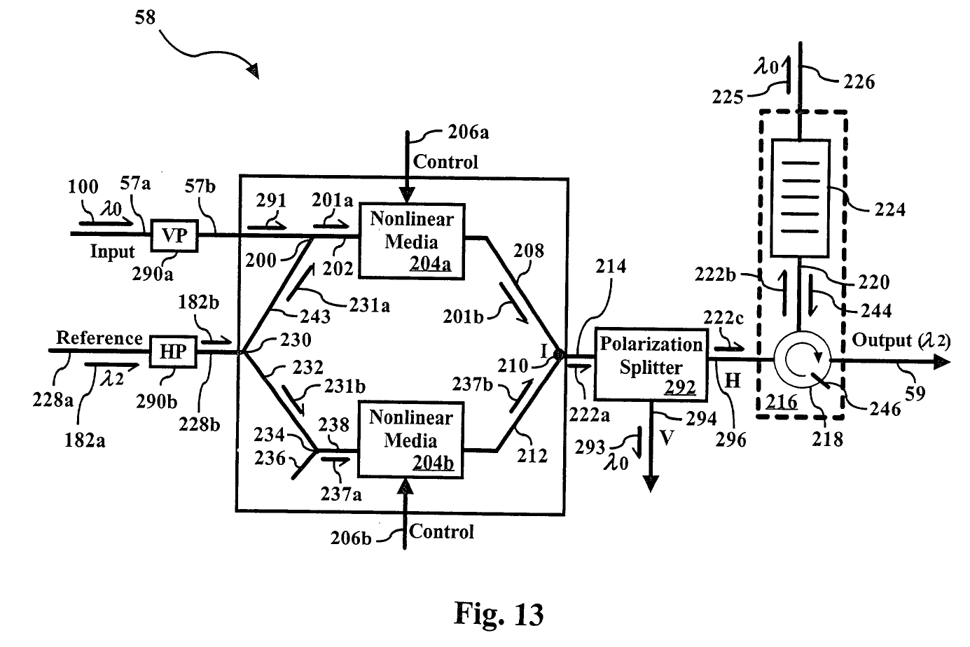

Referring to FIG. 13, data stabilizer 58 involving polarization as a means of discrimination and improving the signal-to-noise ratio (SNR) is shown. One embodiment of data stabilizer 58 of the Mach-Zehnder co-propagating type is shown. Input signal 100 characterized by wavelength λ0 and containing photonic information enters on line 57a and enters polarization stabilizer 290a having a vertical polarization orientation (VP). Polarization stabilizers may be of two types: vertical or horizontal where the vertical and horizontal is somewhat arbitrary but used to distinguish two distinct orthogonal polarization orientations. Other designations might be used, but for the sake of clarity and consistency, vertical and horizontal are used in this case.

Polarization stabilizer 290b has a horizontal polarization orientation (HP). The polarization orientation of a given signal or photonic signal line may be referred to using several essentially equivalent terms such as its “polarization orientation”, its “polarization”, or its “orientation”. Polarization stabilizers 290a and 290b may be constructed several different ways. A first technique (a) consists of a polarization randomizer followed by a polarization filter of appropriate orientation. A second technique (b) involves using a polarization fixer, which receives a signal of arbitrary polarization and converts it so a desired fixed orientation. A third type of polarization stabilizer (c) may be used for signals of known polarization wherein a polarization rotator may be used to rotate the known polarization signal to a desired polarization orientation.

As signal 100 passes through polarization stabilizer 290a which is of the vertical polarization orientation, its polarization is stabilized to a the vertical polarization orientation and output on line 57b as signal 291 where it proceeds until it comes to coupler junction 200 and is attenuated thereby. The signal portion of interest continues on line 202 as signal 201a and enters the nonlinear media 204a controlled by control line or lines 206a. After passing through nonlinear media 204a, the signal 201 exists on line 208 as signal 201b and proceeds to coupler junction 210 where it is reduced in amplitude by the coupler junction. The signal of interest proceeds down line 214 as signal 222a and enters polarization splitter 292. At this point, signals of vertical polarization orientation are output on line 294 as signal 293. Thus, signals characterized by wavelength λ0 are output on line 294 because of the polarization orientation initially imposed upon them by polarization stabilizer 290a.

Reference signal 182a characterized by wavelength λ2 enters data stabilizer 58 on line 228a, and enters polarization stabilizer 290b which is of a horizontal polarization orientation. Signal 182b exits polarization stabilizer 290b having a horizontal polarization orientation on to line 228b and proceeds to junction 230 where signal 182b is split into two parts 231a and 231b. Signal 231a proceeds down line 243 and continues until it enters coupler junction 200 where it is reduced in amplitude and exits the junction as part of signal 201a on line 202. Signal 201a is composed of two parts, a first part arising from signal 291 characterized by wavelength λ0 and having a vertical polarization orientation, and a second part arising from reference signal 231a characterized by wavelength λ2 and having a horizontal polarization orientation. Signal 201a enters nonlinear media 204a wherein the reference signal part of signal 201 a characterized by wavelength λ2 is modulated with information from the input signal part of signal 201a characterized by wavelength λ0. The difference in polarization orientation between the two fractional parts of signal 201a does not interfere in any substantive way with the nonlinear interaction that occurs in nonlinear media 204a. In the nonlinear media 204a, the reference signal characterized by wavelength λ2 is modulated by the input signal characterized by wavelength λ0 and the resultant signal is output on line 208 as signal 201b and proceeds down line 208 to interferometric junction 210.

Signal 231b proceeds from junction 230 down line 232 until it encounters junction 234 where it is reduced in amplitude before continuing on line 238 as signal 237a. Line 236, which is also connected to coupler 234 may be an alternate input, or remain unused. Signal 237a enters nonlinear media 204b controlled by control line or lines 206b. Signal 237a after passing through nonlinear media 204b is output on line 212 as signal 237b where it travels to interferometric coupler junction 210. At interferometric junction 210, signals that are mutually coherent and have a common origin from signal 228b interact in an interferometric manner. Signal 237b characterized by wavelength λ2 and the fractional part of signal 201b characterized by wavelength λ2 interact interferometrically, resulting in an interferometric output on line 214 which is part of signal 222a. Signal 222a enters polarization splitter 292 where signals originating from the reference signal 182a characterized by wavelength λ2 are of the horizontal polarization orientation, and consequently pass through polarization splitter 292 and proceed out line 296 as signal 222c. Signal 222c enters filter 216 wherein all components characterized by wavelength λ0 are delivered out on line 226 as signal 225 and all components characterized by wavelength λ2 are delivered out on line 59.

The polarization discrimination arrangement consisting of polarization stabilizers 290a, 290b and the polarization splitter 292 accomplish a similar function to filter 216. Their functions are not identical but have some similarities. Both of them tend to improve the signal-to-noise ratio of the desired signal characterized by wavelength λ2 passing through the Mach-Zehnder configuration. The polarization discrimination approach involving components 290a, 290b, and 292 need not be used simultaneously with the filter approach involving filter 216. Either approach may be used separately. However, there is a signal-to-noise ratio improvement when both approaches are employed simultaneously.

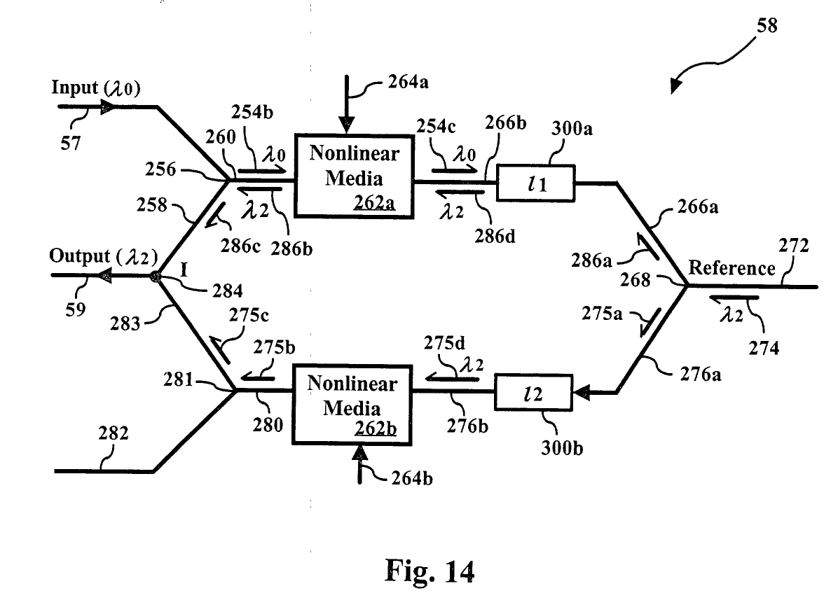

Referring to FIG. 14, photonic data stabilizer 58 of the Mach-Zehnder counter-propagating configuration type receives photonic reference signal 274 characterized by wavelength λ2 on line 272. Signal 274 travels on line 272 to coupler junction 268 where it is split into two power fraction parts, 286a and 276a. The two signal fractions 286a and 275a need not be equal. In some embodiments it is advantageous to have them be equal. In other embodiments it may be advantageous to have them be asymmetrical, that is unequal. The first power fraction 286a proceeds down line 266a until it encounters line length 300a. Line length 300a may be considered as representative of the optical path length, which is not necessarily identically equal to the physical path length. For purposes of discussion, the line length 300a will be considered as a distinct entity, even though in practice, it may not be recognized as such. Reference signal 286a enters line length 300a, exits the same as signal 286d, and proceeds on line 266b until it encounters nonlinear media 262a controlled by control line or lines 264a. Signal 286d exits nonlinear media 262a as signal 286b on line 260 where it encounters coupler junction 256 and is split into two parts. A first part of signal 286b goes down line 57 and is generally wasted or used for monitoring purposes. A second part 286c proceeds down line 258 until it encounters interferometric junction 284. The signal power fraction 286c entering junction 284 represents a power fraction of the total power incident on the junction.

Returning to coupler junction 268 and following the power fraction 275a which goes down line 276a passes through the photonic line length representation 300b and is output on line 276b as signal 275d. Both optical path length elements 300a and 300b are representative of the photonic paths through which the signals pass. The photonic path lengths 300a and 300b refer to the optical length of the path that a photon sees which is not exactly equivalent to the physical length. That is, if a photon passes through a high-dielectric medium it has a different effective optical photonic length than if it passes through a medium of low-dielectric constant, when the physical lengths of the two media are identically equal. The time spent as the photon traverses the two media will be different. The physical path length and the photonic path length are not necessarily equivalent. The photonic path length of some paths must be precisely controlled in a number of preferred embodiments in order to effect the desired interaction. The exact physical length is generally not critical—only as it affects the phase delay of the signal traversing that particular path. A configuration may be referred to as being symmetric when all of the coupling factors, path length factors, and gain or attenuation factors are equilibrated for the respective arms when using an interferometric configuration. For non-interferometric configurations matching photonic path lengths for symmetry purposes is generally not necessary. They need not be equal. In some embodiments they may be equal. In alternate embodiments, even interferometric ones, it may be advantageous to make the path lengths unequal. Signal 275d passes through nonlinear media 262b and becomes signal 275b. Signal 275b proceeds on line 280 until it encounters coupler junction 281 where the signal is split in amplitude, a first fraction of which goes down path 282 where it is generally absorbed or used for monitoring and feedback control. The second fraction of signal 275b goes down line 283 as signal 275c until it encounters interferometric junction 284. The coupling ratio required at junction 284 to obtain a desired output from the input power fractions 275c and 286c may require equality in the power fractions in some embodiments and inequality in other embodiments to meet the same objective of obtaining the desired junction output. Care must be taken to be sure that the requisite interferometric conditions are satisfied relative to coherence, phase, polarization, and amplitude. After an interferometric interaction at junction 284 between signals 275c and 286c, the output signal goes down line 59 as the output signal at wavelength λ2.

Consider nonlinear media 262a located between photonic signal paths 276b and 280, relative to nonlinear media 262b located between photonic signal paths 286d and 286b. Nonlinear media 262a and 262b, both of which are of the type 90 discussed previously, represent nonlinear elements encountered in data stabilizers 58 placed in the paths of a data stabilizer arrangement. The properties of multiple nonlinear elements 262 in a given embodiment may be essentially identical, differ in a small degree, or substantially, in properties such as gain, loss, saturation, phase delay, frequency response, or combinations of the same. Differences in nonlinear elements 262 may be intentional fundamental differences, intrinsic by design of the relevant fabrication parameters, device length, and geometry. Other nonlinear element differences may follow as consequences of the selected operating conditions such as bias levels involving current, voltage, or energy from electronic, photonic, thermal, radio-frequency, or chemical bias sources. A specific embodiment may have a high degree of symmetry in all nonlinear elements 262 or vary therefrom in one or more of the elements noted above, in isolation, or in combination with other biasing elements. Some embodiments considered may appear to be symmetric in detail, when lacking notation to the contrary, but such is not necessarily the case. There are several elements that may or may not be partially or totally symmetric. In some preferred embodiments, the parameters discussed are symmetric. In other embodiments, the parameters of interest may be asymmetric or anti-symmetric in part or in multiple aspects in order to facilitate specific objectives of the invention. For example with coupler junction 268 the power fractions 275a and 286a arising from the splitting of signal 274 may or may not be equal. The line lengths 300a and 300b, may, or may not, be equal depending on the desired effect in the given embodiment. Referring to the nonlinear media 262a and 262b—they may agree or vary in such parameters as gain, phase delay, their physical length, their attenuation or other such parameters.

There are at least four sets of parameters, which may be adjusted to be symmetric or asymmetric. The four parameters are: the splitting ratio of coupler junction 268, which is a splitter for the incoming reference signal; the photonic signal path lengths of 300a and 300b; the physical geometry and operational photonic properties of nonlinear media 262a and 262b which may be controlled separately to effect differences in gain, differences in attenuation, differences in phase delay, or differences in frequency response, and lastly, the power fraction coupling ratio of coupler junction 284. The four parameters cited can be adjusted independently to produce a desired output. In the counter-propagating Mach-Zehnder embodiment shown in FIG. 12 and FIG. 14, the desired output on line 59 results from the interferometric interaction of signals 275c and 286c at coupler junction 284. The interferometric requirement at junction 284 to obtain a desired output is that signals 275c and 286c coming in on lines 283 and 258, respectively, be coherent with each other for some portion of the interaction and that they be of an appropriate amplitude to effect significant if not maximal interaction. Coherence means that the interacting signals are of essentially the same wavelength, have similar polarization properties, have related modal properties when confined to a guiding structure, and that the signals are correlated in time and space such as that produced when two signals originate from the same source and are separated by less than the coherence length and coherence time of their common source at the location of their interferometric interaction. An interferometric configuration may be made asymmetric in any one of several different parameters so that there may be multiple asymmetries or compound asymmetries in a given configuration. Simply referring to a configuration as being asymmetric does not tell the whole story, as there are multiple variables in which it may be asymmetric.

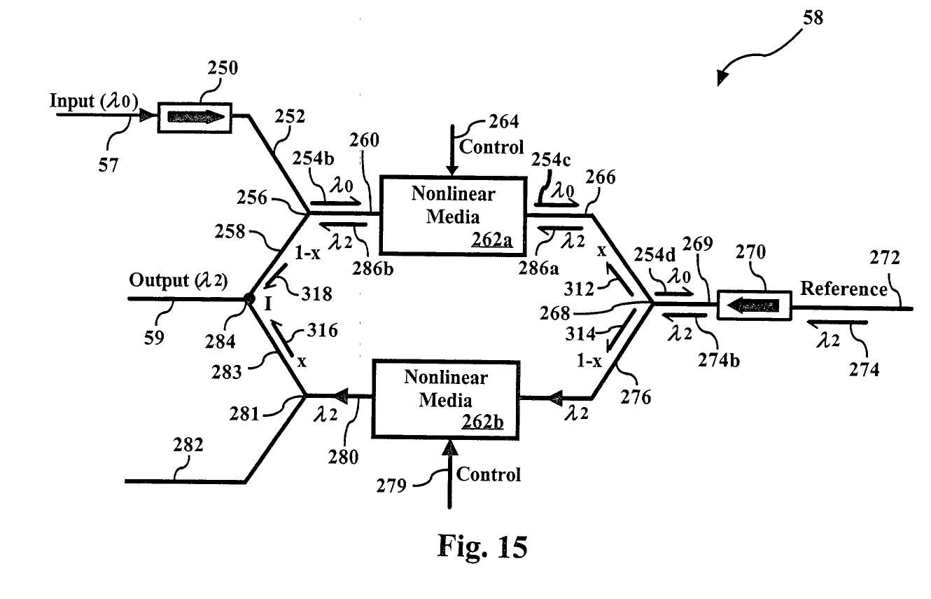

Referring to FIG. 15, a data stabilizer 58 of the asymmetric counter-propagating Mach-Zehnder type is shown having two interferometer arms. The first interferometer arm consists of the combination of paths 266, 260, and 258 with intervening nonlinear media 262a. The second interferometer arm consists of the combination of paths 276, 280, and 283 with intervening nonlinear media 262b. The elements that make the interferometer configuration asymmetric are the power splitting ratio of coupler junctions 268 and 284. Junction 268 splits the power of incoming reference signal 274b into two unequal parts 312 and 314, designated as power fraction X and power fraction 1−X, respectively. The normalized sum of the power fractions that enter and are transmitted through an individual coupler junction such as 268 or 284 is unity. At the opposite end of the Mach-Zehnder interferometer photonic signals 316 and 318 enter junction 284. The combination of signals 316 and 318 is asymmetric in the sense that signal 316 has a power fraction of X and signal 318 has a power fraction of 1−X. Signals 312 and 316 have power fractions of X while signals 314 and 318 have power fractions of 1−X. Thus, the Mach-Zehnder is asymmetric but in a complimentary fashion; one end is complimentary to the other in order to achieve a desired objective of appropriate interferometric interaction at the output interferometric junction 284. This is but one type of complimentary asymmetry in a data stabilizer 58 of the Mach-Zehnder interferometer type.

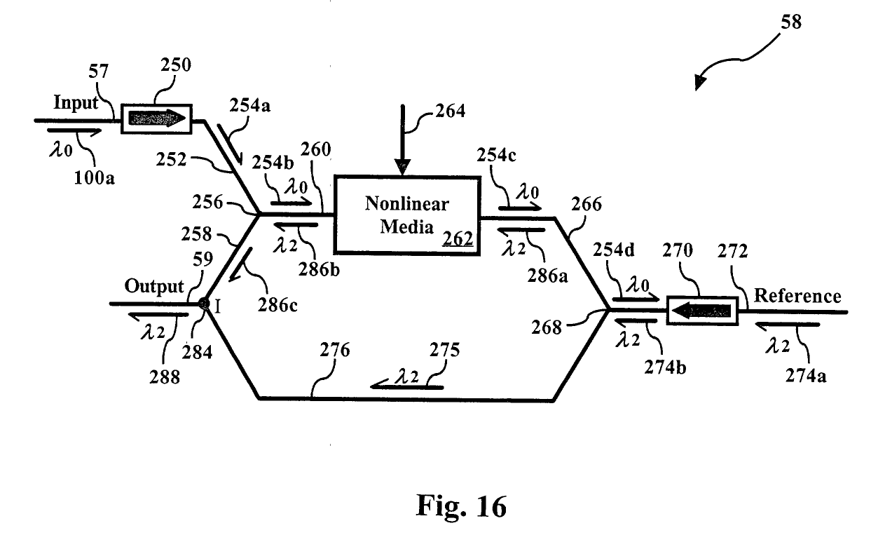

Referring to FIG. 16, a data stabilizer 58 of the counter-propagating asymmetric Mach-Zehnder type is illustrated. In the present embodiment, the asymmetry is formed by the lack of a nonlinear media in line 276. In the path connecting lines 266 and 260, there is a nonlinear medium 262 inserted. Path 276 contains no such nonlinear media, creating an asymmetry.

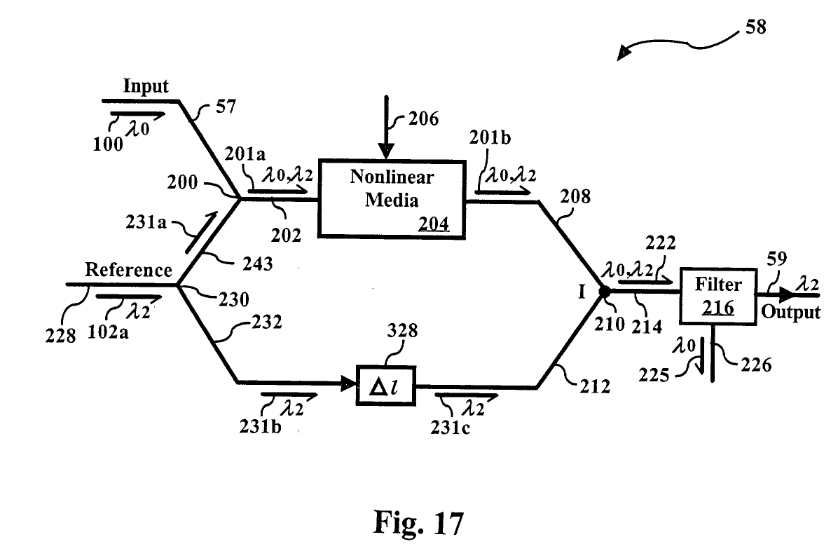

Referring to FIG. 17, a data stabilizer 58 of the co-propagating Mach-Zehnder asymmetric type is formed by having multiple asymmetries. A first asymmetry results from having nonlinear media 204 between signal paths 202 and 208, while not having a nonlinear media element corresponding thereto between signal paths 212 and 232. A potential asymmetry in gain, attenuation, phase delay and any other parameter involving the nonlinear media 204 is possible. A second asymmetry exists because coupler junction 200 is located between lines 202 and 243 while no corresponding coupler junction counterpart exists along path 232. Signals passing through lines 202 and 243 will have an attenuation loss due to the presence of coupler 200 which extracts a power fraction of signals passing through. Signals traversing line 232 will not lose a comparable power fraction because no coupler junction corresponding to coupler 200 is present. A third form of asymmetry potentially exists because of the path-length difference between the two paths going between junction 210 and junction 230. Data stabilizer 58 has a representative path-length difference 328 between lines 232 and line 212 of one arm of the Mach-Zehnder interferometer. The path-length difference 328 is representative of all of the photonic line length differences between the two paths; one of which begins at coupler junction 230, proceeds down line 243 through line 202 through the nonlinear media 204, through line 208 to the interferometric junction 210. The second path, which begins at coupler junction 230, proceeds down line 232 through the representative line length difference 328, down line 212 to the interferometric coupler junction 210. The path-length difference 328 is representative of all the relative photonic path-length differences between the two path lengths described. The relative path-length difference will result in a phase delay for one of the signals traveling between the two junctions relative to the signal traversing the other. Relative path-length differences between two arms in an interferometric configuration can have significant consequences.

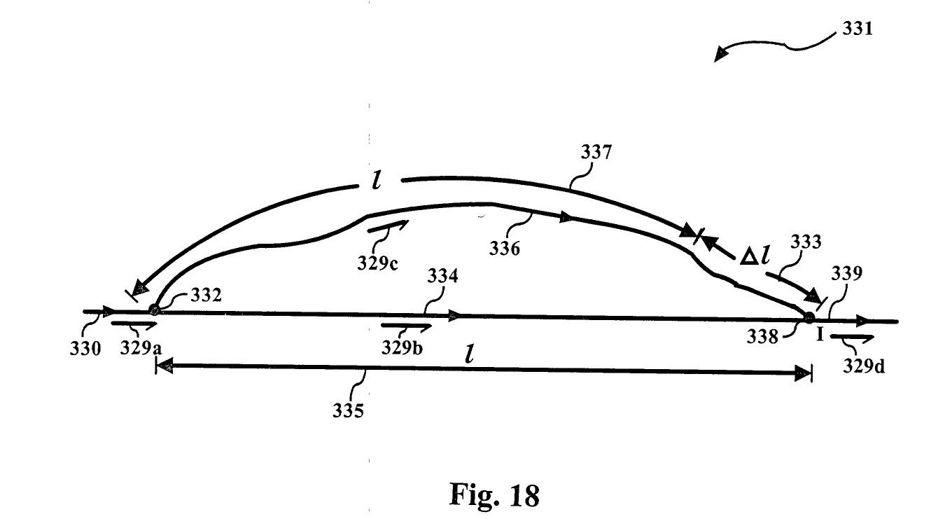

Referring to FIG. 18, specifically, while referring generally to FIGS. 11-23, an interferometer 331 having input path 330 designed to receive photonic input data 329a connects to splitter junction 332 which has two output paths 334 and 336. Photonic signal paths 334 and 336 are characterized respectively by photonic path lengths 335 and 337. A distinction exists between the physical path length and the photonic path length. The physical path length is determined by measuring the physical distance of a path. The photonic path length is dependent upon: (1) The refractive index of all path segments composing the complete path from beginning to end at the specified wavelength, (2) The physical length of each path segment, (3) The geometry of each path segment and the orientation of the incident electromagnetic radiation relative to whatever waveguiding structure may be involved, (4) The photonic mode of the electromagnetic radiation at the specified wavelength traversing the path. The two orthogonal polarization states of a given photonic signal constitute distinct “modes”, even in “single-mode” fiber. It is the composite integration of the four factors just noted that determines the effective “photonic path length”. The two photonic path lengths 335 and 337 differ by some finite measure 333 that may be large or small. Signal paths 334 and 336 connect to interferometric coupler junction 338 that is connected to output path 339. Signal 329a after entering on line 330 is split by splitter junction 332 into two fractional signal parts 329b and 329c which travel down paths 334 and 336, respectively to junction 338 where the two fractional signal parts interact interferometrically. Upon arriving at the interferometric coupler junction 338 the two relatively coherent signals 334 and 336 will differ in phase by some finite amount related to the path-length difference 333. The interferometric interaction of signals 329b and 329c at junction 338 is dramatically affected by the phase difference resulting from path-length difference 333. As a result of the signal interaction at interferometric coupler junction 338 output signal 329d is generated and output on path 339.

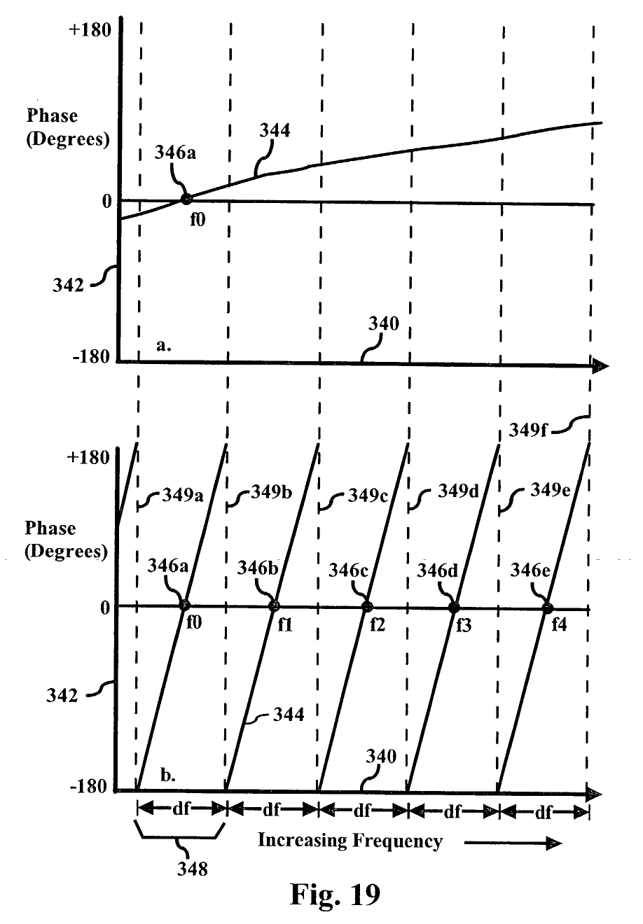

Referring to FIG. 19, phase difference as a function of frequency 344 is illustrated. Vertical axis 342 represents the phase difference, in degrees, between signals 329b and 329c as a function of increasing frequency 340 on the horizontal axis. Two cases for path-length differences 333 are considered. The phase variation with frequency is small if ΔL is small as shown in FIG. 19a. When ΔL is small relative to the photonic wavelength of photonic signals traversing paths 334 and 336 then a phase versus frequency output as shown in FIG. 19a results, wherein the phase difference changes gradually while the frequency is varied over a relatively broad range. If ΔL is large, then the phase difference increases much more dramatically with increasing frequencies, as shown in FIG. 19b.

In both instances, when ΔL is small and when ΔL is significant to large relative to a wavelength, there will be phase null points 346 designated as f0, f1, f2, f3 and f4 . . . , at which points the phase difference between the two lines signal paths 329b and 329c is a multiple of 2π. The phase difference is either zero or modulo 2π at phase null frequencies 346, hereafter referred to as null frequencies or null points. From an interferometric point of view, the two signals 329b and 329c being combined interferometrically cannot tell the difference between any of the operating points 346, providing ΔL does not exceed the coherence length of the photonic source providing signal 329a. The transition frequencies 349 of phase difference, and the null frequencies 346 are spaced widely in frequency when ΔL is relatively small and are closely spaced in frequency when ΔL is large, as shown in FIG. 19. Frequency increment 348 is relatively small when ΔL is large. Even though the null frequencies 346a, 346b, 346c, 346d and 346e are different in phase, the interferometric circuit cannot tell the difference. The result is that there are multiple frequencies 346 f0, f1, f2, f3, f4, . . . at which the effective phase difference between the signals traversing the two paths 334 and 336 is zero.

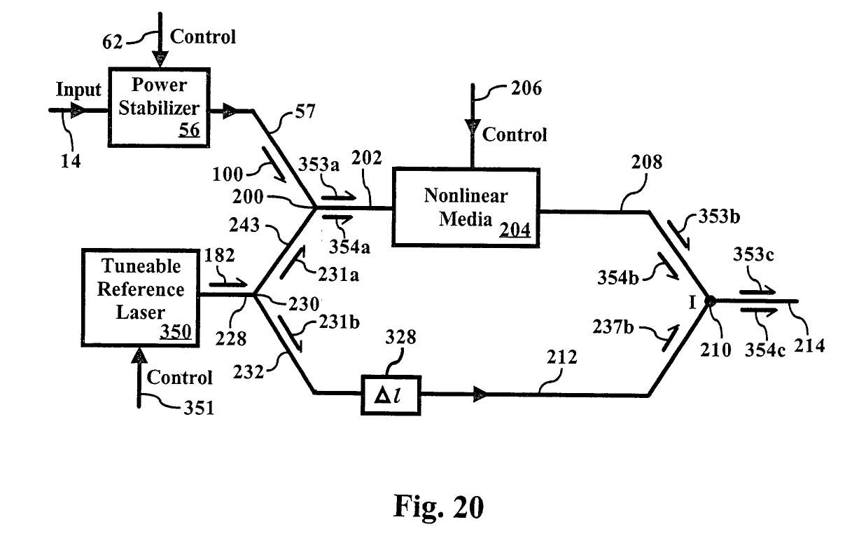

Referring to FIG. 20, one embodiment of the present invention utilizes a co-propagating asymmetric Mach-Zehnder interferometric configuration. Photonic data input on line 14 is stabilized by power stabilizer 56 which is controlled through lines 62 and outputs a photonic signal 100 on line 57. Signal 100 travels through splitter junction 200 where it is attenuated and continues down line 202 as signal 353a to nonlinear media 204 which receives control direction through line or lines 206 and outputs signal 353b on line 208 where the signal proceeds to interferometric junction 210. The part of signal 353b that exits junction 210 on line 214 becomes signal 353c.

Reference source 350 provides reference signal 182 under direction of control line 351 which proceeds down line 228 to splitter junction 230 where the reference signal is split into power fractions 231a and 231b which then proceed down paths 243 and 232, respectively. Power fraction 231a on line 243 travels to splitter junction 200 then down line 202 as signal 354a through nonlinear media 204 where it is modulated by data signal 353a and is output on line 208 as modulated data signal 354b which then goes to interferometric junction 210. Power fraction 231b proceeds from splitter junction 230 down line 232 through photonic path-length difference 328 and continues on line 212 as signal 237b and enters interferometric coupler junction 210. At the interferometric junction 210, power fractions 237b and 354b interact interferometrically and output signal 354c on line 214. In practice, it is very difficult to have signals 354b and 237b match perfectly at interferometric junction 210. Because of path-length difference 328 in the Mach-Zehnder configuration it is possible to use tunable reference source 350 to adjust the frequency of reference signal 182 to be one of the null frequencies 346 such that a phase match exists between signals 237b and 354b at interferometric junction 210. In some embodiments, it is advantageous to make the path-length difference 328 large. The larger the path-length difference 328, then the closer together will be the zero phase points 346a, 346b, 346c, 346d and 346e giving more choices more closely spaced in frequency from which to choose. The actual tuning to the zero phase difference points 346 is accomplished by the control line 351 exerts on tunable reference source 350. The control direction of line 351 is derived from signal 354c on line 214 or a subsequent signal derived therefrom. The sample is taken at a point after the interferometric junction, whether the configuration be co-propagating or counter-propagating. Stated another way, a sample is taken of the signal that interacts interferometrically, after it has passed through the interferometric junction, downstream, in whichever direction is applicable. In some embodiments, it may not be desirable to tune the reference frequency over a wide range because of system requirements further down line 214. In such embodiments it may be advantageous to choose a priori a line length 328, which is sufficiently large to allow null frequencies 346 to be sufficiently closely spaced, that only a slight adjustment in reference source 350 is required for proper phase matching. One embodiment that makes phase matching possible at coupler junction 210 is as follows: The input power level of the data signal entering on line 14 is stabilized by power stabilizer 56 using control line or lines 62. A priori the path-length difference 328 is chosen to be sufficiently large such that the frequency variation required in order to find a null phase point 346 is sufficiently small. The power splitting ratio at junction 230 is set such that the gain or loss of signal 354a as it passes through nonlinear media 204 is such that the power fraction 354b is essentially equivalent in amplitude to power fraction 237b at interferometric coupler junction 210. The parameters being adjusted or stabilized include: the signal power output on line 57 as signal 100, the frequency and power of output signal 182 of reference source 350, the power splitting ratio of splitter junction 230, the power combining ratio of interferometric coupler junction 210, the path-length difference 328, and the gain and phase characteristics of nonlinear media 204. By monitoring and setting the parameters indicated, the desired control is achievable to obtain maximal interferometric interaction and output at coupler junction 210. Although a co-propagating configuration is shown, an alternate embodiment employs a counter-propagating configuration.

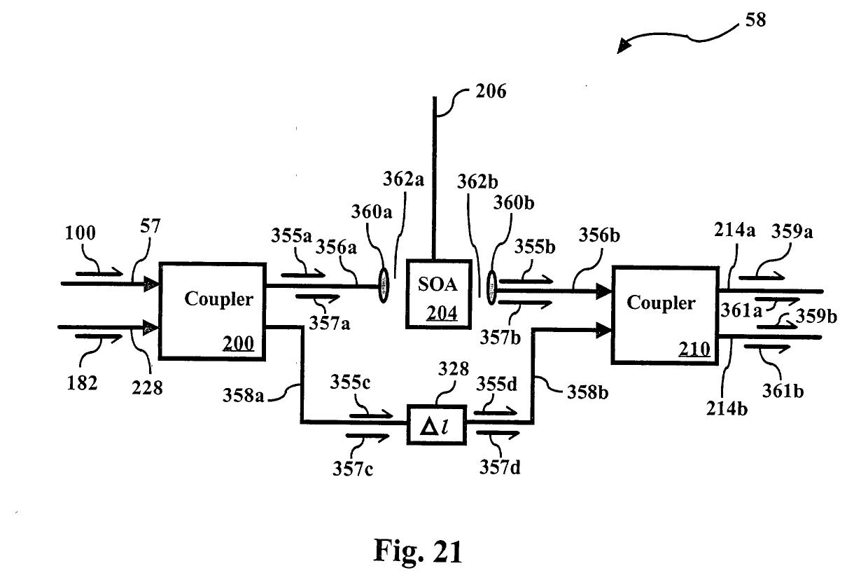

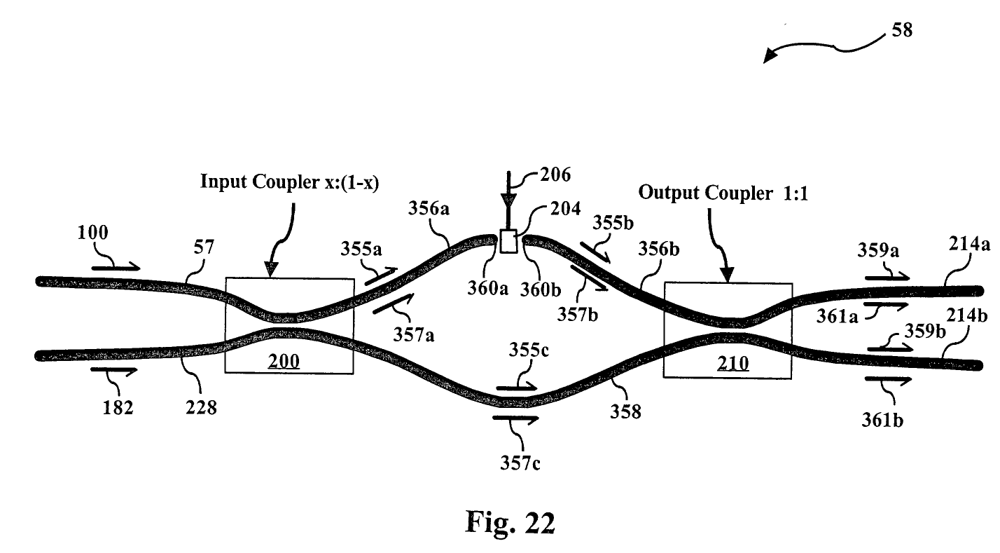

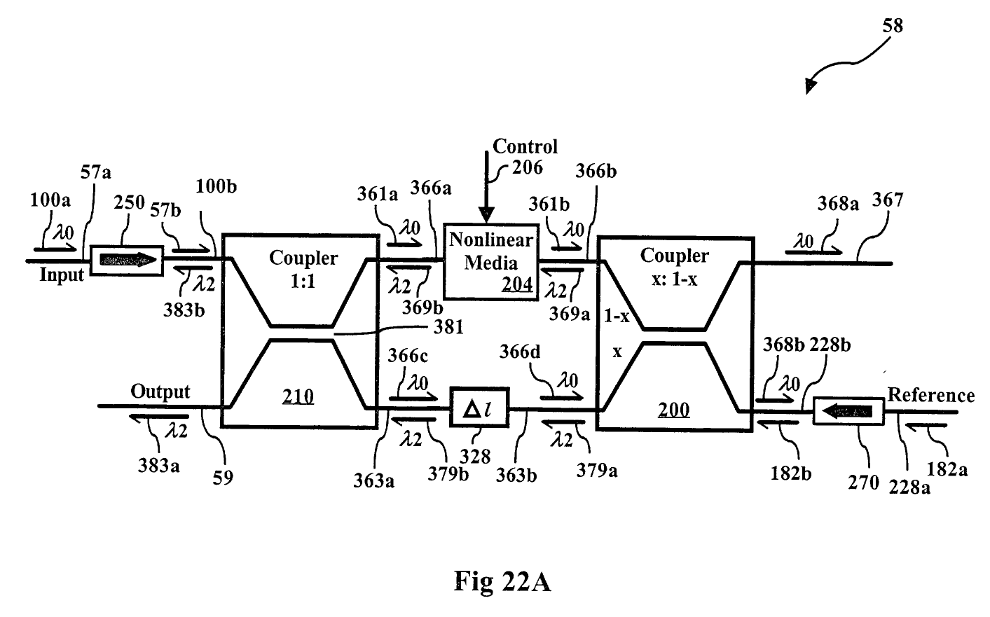

Referring to FIG. 21 and FIG. 22, specifically while generally referring to FIGS. 10 through 23 an alternate embodiment of data stabilizer 58 of the present invention using a nonsymmetrical, co-propagating Mach-Zehnder configuration receives photonic input signal 100 on input path 57 which enters coupler junction 200. Signal 100 is split into two parts by coupler 200 and becomes signals 355a and 355c continuing on paths 356a and 358a, respectively upon exiting coupler 200. Signal 355a travels down path 356a to lens 360a where the signal is focused by lens 360a before traversing space 362a and entering the aperture of nonlinear media 204. After passing through media 204 signal 355a emerges into space 362b as signal 355b and enters lens 362b which focuses the signal onto path 356b. Signal 355c passes down line 358a through path-length difference 328 onto line 358b and becomes signal 355d. Signals 355b and 355d interact interferometrically with each other in coupler junction 210 to become signals 359 on lines 214. Interstitial spaces 356a and 356b may be composed of air, liquid, solid, or cured media having adequate photonic transmissivity at the wavelengths being used.

Reference signal 182 enters coupler 200 on line 228 and is split into two parts to become signals 357a and 357c that pass down paths 356a and 358a, respectively. Signal 357a follows identically the same path as signal 355a until coupler 210 is encountered. Signal 357c follows identically the same path as signal 355c until coupler 210 is encountered. Signals 357b and 357d interact interferometrically with each other in coupler junction 210 to become signals 361 on lines 214. In data stabilizer embodiment 58 illustrated in FIGS. 21, 22, and 23 having coupler 200 and coupler 210 each be 50/50 or 1:1 couplers is not generally optimal. In a preferred embodiment of data stabilizer 58 nonlinear media 204 is an SOA (semiconductor optical amplifier) and has significant gain. Input power levels of input signal 100 and reference signal 182 are adjusted dynamically and the coupling ratio of coupler 200 is set such that the signal gain experienced by signal 357a in passing through nonlinear media 206 is offset by the splitting ratio of splitter 200. The designed outcome is that complimentary signals 357b and 357d upon entering coupler junction 210 are essentially equal in amplitude, have the appropriate phase, and are of the same polarization orientation for optimal interferometric interaction. The embodiment illustrated in FIGS. 21, 22, and 23 as well as the other embodiments of data stabilizer 58 of the present invention can be operated in the operational modes involving cross gain modulation (XGM), cross phase modulation (XPM), or combinations involving both mechanisms together. For the co-propagating interferometric embodiments shown in FIGS. 21, 22, and 23, a filter such as filter 216, shown in FIG. 11, or an equivalent mechanism may be required on the interferometric output to separate wavelengths of the input signal 100 from wavelengths of the reference signal 182. The present embodiment may be fabricated in fiber or planar waveguide or in any other media common to the art. The present embodiment receives photonic signal line 356a coming in to photonic lens 360a, followed by space 362a, which may be filled with air or other suitable optical media before entering nonlinear media 204 which in this case may be an SOA, a nonlinear polymer, a crystal, or other photonic nonlinear material. The purpose of the lenses 360 is to match the mode field diameters of lines 356 with the mode field diameters of the nonlinear media substrate 204. Paths 356 may be fibers or photonic waveguides etched in a substrate or any other means suitable for carrying photonic data. Coupler 210 may be fabricated such that it has frequency-selective properties such as low pass, high pass, band pass, or band reject properties. By using frequency-selective photonic coupling properties filter 216 may not be necessary by suitable choice of the frequency transmission parameters of the coupler. Lenses 360a and 360b may be lenses formed onto fibers 356a and 356b, lenses formed on the end of a waveguide substrate, or discrete elements. The lens properties are chosen such that the required focusing properties are achieved in order to match the effective optical aperture of the nonlinear media 204 at each end to the desired photonic circuit. The end characterized by the space 362a and the end characterized by the space 362b. The filling of the space 362a and 362b may be done with optical material that is ultraviolet (UV) cured material, initially put in as a liquid and later solidified in place. Other materials for filling spaces 362 include liquid, gelatinous, and solid material having an appropriate refractive index for matching of photonic signal input and output paths.

Referring to FIG. 22, a data stabilizer of the asymmetric Mach-Zehnder type may be fabricated using photonic fibers for input paths and output paths designated respectively as paths or lines 57, 228 and 214. The photonic lenses 360a and 360b may be fabricated on and from the incoming fibers 356a and 356b. Lacking in the prior art are good fiber lenses. Others have used lens-making techniques such as melting fiber ends, dabs of epoxy on fiber-ends, conical tapers, etched fiber ends, and other crude approximations to a good spherical lens. Lack of optical preciseness results in unnecessary losses and reduced coupling efficiency. Nonlinear media 204 may have specific optical aperture requirements, which must be met by the lens characteristics of lenses 360a and 360b if efficient photonic processing is to be achieved.

Referring to FIG. 22A, an alternate embodiment of data stabilizer 58 of the present invention uses a compound asymmetric counter-propagating Mach-Zehnder configuration to receive photonic input signal 100a characterized by wavelength λ0 on input path 57a. Signal 100a passes through isolator 250 onto path 57b, enters coupler 210, and is split in amplitude to become signals 366a and 366c on paths 361a and 363a, respectively. Signal 366a enters nonlinear media 204, controlled by line 206, and exits as signal 366b on line 361b where it continues until it enters coupler 200. Signal 366c passes down line 363a through path-length difference 328 onto line 363b and becomes signal 366d. Signals 366b and 366d meet at coupler 200. At coupler 200 the relatively coherent signals interact interferometrically, but only to a limited extent because signal 366b has been amplified significantly by nonlinear media 204 and coupler 200 is designed to have a significantly unequal splitting ratio. The effect on signals 366b and 366d is that even though they are relatively coherent, their relative amplitudes are grossly disparate. The result of signals 366b and 366d characterized by wavelength λ0 entering coupler 200 is signals 368a and 368b also characterized by wavelength λ0 exiting on lines 367 and 228b, respectively. Signal 368b enters isolator 270 and is absorbed. Signal 368a may be used for measurement purposes or be discarded.

Photonic reference signal 182a characterized by wavelength λ2 enters data stabilizer 58 on line 228a, passes through isolator 270 onto line 228b and into coupler 200 where it is split in amplitude and output on lines 361b and 363b as signals 369a and 379a, respectively. Signal 379a passes through photonic path length difference 328 to path 363a, becomes signal 379b and travels to coupler 210. Signal 369a passes through nonlinear media 204, is modulated with the information content of signal 366a, exits the nonlinear media as signal 369b on line 361a, and enters coupler 210. Coupler 200 is designed with a photonic power splitting ratio to essentially counter the amplification that signal 369a experiences in going from path 361b to path 361a. Stated another way, the difference in amplitude of signals 369a and 379a caused by the unequal splitting ratio of coupler 200, is essentially matched by the gain of nonlinear media 204 such that signals 369b and 379b are essentially equal in amplitude when they meet at interferometric junction 381. The result is optimal interferometric interaction of signals 369b and 379b to produce the desired output signal 383a. The present counter-propagating embodiment requires a minimum count of expensive photonic components, such as nonlinear media element SOAs, and yet provides the requisite data stabilizing functionality. The present embodiment produces two signals characterized by wavelength λ2, 383a and 383b, carrying essentially the same information albeit in complimentary forms, ea. in an inverted and a non-inverted form. Ordinarily signal 383b is discarded, but an alternate embodiment utilizing a circulator in place of isolator 250 can be used to output and use both stabilized information signals 383a and 383b is possible. Another alternate embodiment employs a co-propagating configuration of the same general form.

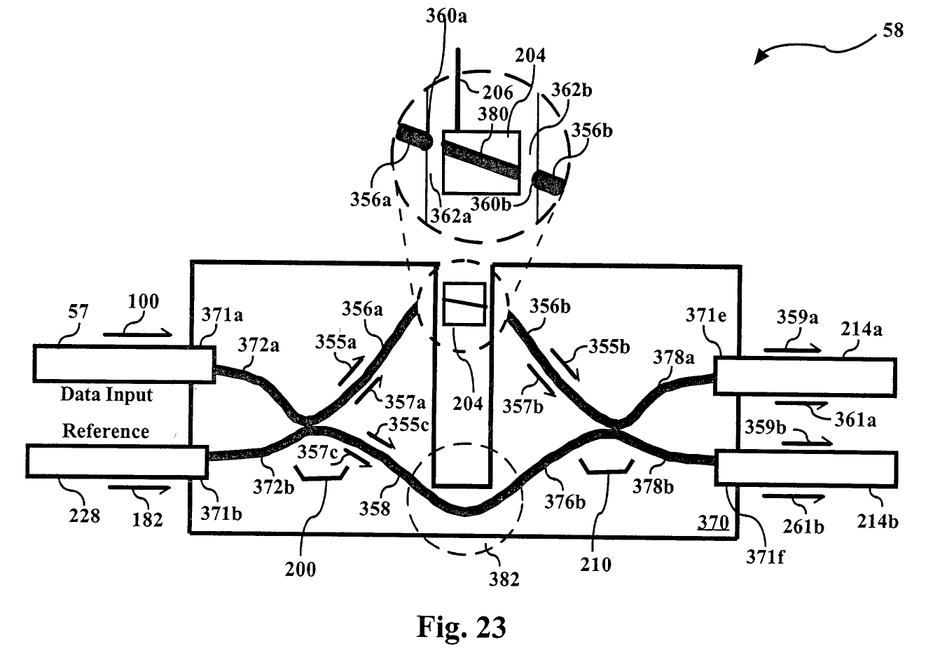

Referring to FIG. 23, another preferred embodiment of data stabilizer 58 has photonic inputs 57 and 228 composed of optical fibers which sit in grooves or notches 371a and 371b, respectively, fabricated in substrate 370 which contains other components also. Photonic input path 57 is aligned with waveguide structure 372a, such that the optically transmissive core of incoming line 57 and waveguide structure 372a are aligned sufficient to transfer photonic information from one to the other. Photonic data 100 is received by line 57 and proceeds down photonic waveguide line 372a until it encounters coupler 200 shown having waveguide lines 372a and 372b in close proximity to each other. Photonic data signal 100 upon entering coupler 200 is split into signals 355a and 355c and coupled into lines 356a and 358, respectively. Signal 355a travels on line 356a through lens 360a, space 362a, nonlinear media 204, space 362b, and into lens 360b on waveguide 356b where it becomes signal 355b and enters coupler 210. Nonlinear media 204 may have an active channel 380 through which signals to be operated upon pass. Signal 355c travels on path 358 from coupler 200 to interferometric coupler junction 210 where it interacts interferometrically with signal 355b, passes through waveguide 378 and is output as signals 359 on paths 214. Output lines 214 are seated in grooves or notches 371 prepared for the purpose of fixing, aligning and stabilizing the fibers to substrate 370. Mounting structures 371 may be notches, V-grooves, or inset regions suitable for alignment. Each mounting structure 371 is designed such that the core of the incoming fiber or outgoing fiber is aligned with the central waveguide structure to which it interfaces, with the result that substantially all photonic signal power is transferred from one media to the other. Examples of which are the core of fiber 57 with waveguide structure 372a, the core of fiber 228 with waveguide structure 372b, the core of fiber 214a with the waveguide structure 378a, and the core of fiber 214b with waveguide structure 378b.

Line 228 provides a second input path to photonic data stabilizer 58. The fiber 228 is joined with substrate 370 in a special notch or V-groove arrangement 371b so photonic data is transferred to waveguide 372 as a part of the substrate. Photonic signal 182 proceeds down line 372b to coupler 200 where it is split into signals 357a and 357b which pass down paths 356a and 358, respectively. Signal 357c proceeds on line 358 around flex region 382 to interferometric coupler junction 210. Flex region 382 is designed to be mechanically flexible so that it can be mechanically deformed without damage to the physical structure. Slight deformation of flex region 382 makes it possible to change the size of interstitial space regions 362a and 362b, as needed to effect proper focusing of photonic signal data passing through lenses 360a and 360b onto the ends of active channel region 380 of nonlinear media 204.

The photonic lensing arrangements 360a and 360b may be composed as end surface structures prepared on substrate 370 or they may be lens structures attached to the core structure 370 over the waveguide regions 356a and 356b. The lensing structures 360 may be composed of cured media. Some embodiments may consist of an alteration of media 356 and 358 utilizing such methods as modifying the dielectric profile. Changes in the refractive index profile near the end location of the interstitial media 362a may be made such that focusing capabilities are designed to match the waveguide line 356a with nonlinear media active region 380 and the active medium 380 with the waveguiding structure 356b. The purpose of the lensing structures 360a and 360b is to match the mode field pattern of an incoming photonic signal with the mode field pattern of the outgoing photonic signal carrying media for maximum transfer of energy and information. Substantially all of the energy is to be transferred from one area to the other. The splitter/coupler junction arrangements shown as elements 200 and 210 can be effected in several different ways. The junctions 200 and 210 may split the energy equally or unequally depending on the particular embodiment chosen. The coupling factor may be changed in a number of different ways. The coupling factor for each junction may be set or altered in the design process in several different ways including but not limited to: (1) The physical proximity of photonic transmission lines. For example, line 372a and line 372b when brought closer together tend to couple more strongly. When they are further apart, they couple less strongly, (2) The geometrical shape of the photonic transmission lines affects coupling. That is, line 372a and line 372b may have altered shapes near coupler region 200, in order to effect or prevent coupling in some manner. The same holds true for coupler region 210 with incoming lines 356 and 358 and outgoing lines 378. (3) A third form of adjusting the coupling between two lines can be done by changes in the refractive index of the core, cladding, substrate or intervening material in and around the waveguide media 372, 356, and 378, particularly in the regions 200 and 210 of the desired coupling. (4) A fourth element that may be incorporated in fixing or adjusting the coupling is inhomogeneity in composition of dimensions, of dielectric constants, of spacing, or of periodic perturbations in the regions of coupling 200 and 210. There may be periodically spaced perturbations, irregularly spaced perturbations and the like in order to effect the desired coupling. (5) A fifth element, which may be incorporated, is wavelength or frequency sensitive coupling characteristics, which may be effected particularly using periodically spaced perturbations of any of the parameters cited previously. (6) All of the above five combinations can be used in part, together, or separately as needed in order to effect the desired coupling in the given photonic circuit. The flexible joint 382 is designed such that the spacing of the interstitial spaces 362a and 362b may be altered by mechanical deformation of substrate 370 without breaking the mechanical structure 370 or otherwise damaging its composition. The flex joint is so composed that it may be bent to effect greater control of the coupling between line 374a and the nonlinear media channel 380 and between the nonlinear media channel 380 and the waveguide line 376a. Therefore, in conjunction with lenses 360a and 360b spacing of the interstitial spaces 362a and 362b may also be altered in order to effect maximal coupling.

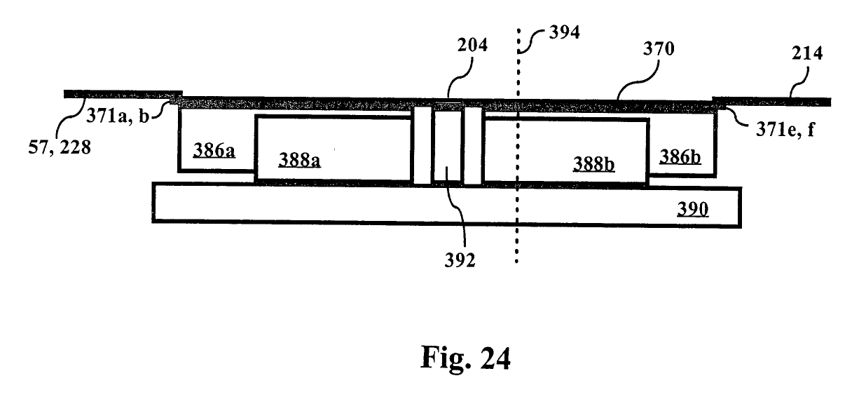

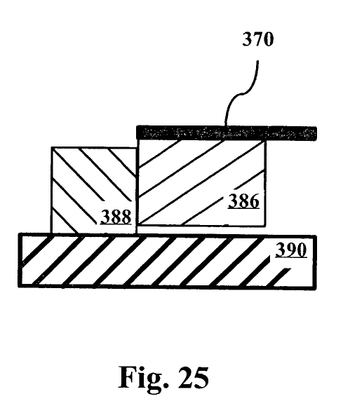

Referring to FIG. 24 and FIG. 25, the physical structure of photonic substrate 370 shown in FIG. 23, requires support of some type. One embodiment of such support is shown in FIG. 24. Substrate carrier 386 supports substrate 370. Carrier 386 is in turn supported by mounting cubes 388 as part of the physical structure. Mounting cubes 388 are in turn positioned on sub-mount 390, which carries the total structure. Post 392 supports nonlinear media 204. FIG. 23 shows a top view of substrate 370. FIG. 24 shows a side view of the structure that supports substrate 370 and the nonlinear media 204. FIG. 25 shows a sliced view made by cut 394 through the mounting elements 386, 388 and 390 as well as the substrate itself, 370.

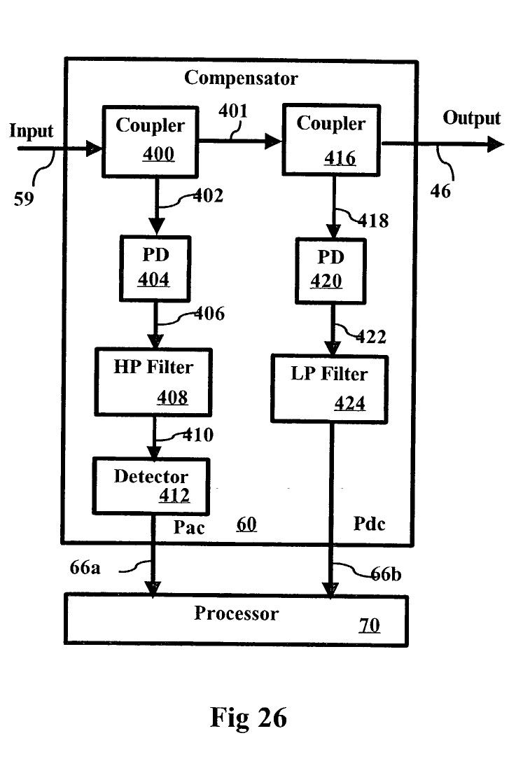

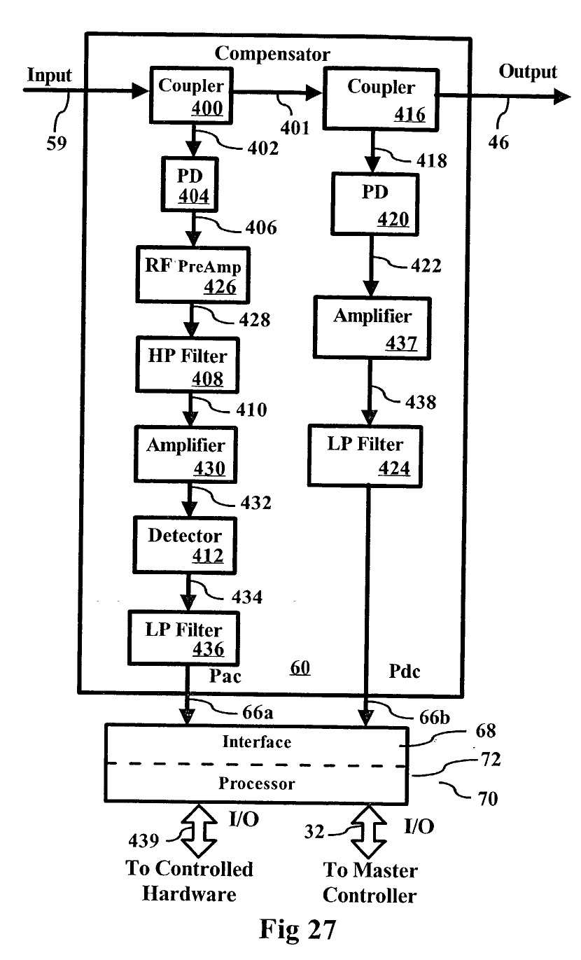

Referring to FIG. 26 and FIG. 27, compensator 60 is illustrated in alternative embodiments. The compensator illustrated in FIG. 26 is fundamental. The additional enhancements of the preferred embodiment shown in FIG. 27 are designed to give better performance. A photonic data input signal enters compensator 60 on line 59 and first encounters coupler 400, at which point a sample—a small fraction of the photonic information signal going down line 59—is taken and re-directed down line 402 to photo detector 404. Photodetector 404 provides an electronic signal on line 406 to high-pass filter 408. After passing through high pass filter 408 the electronic signal passes successively down line 410 to detector 412 where the radio frequency (rf) electronic signal is rectified to become a signal representative of the modulated (rf) portion of the photonic signal on line 59. The output of detector 412 exits the compensator on line 66a to processor 70. The major portion of the photonic signal that enters coupler 400 on line 59 exits the coupler on line 401 with only slightly diminished amplitude. The main body of photonic information on line 59 passes out line 401 and enters coupler 416, which samples a small fraction of the total photonic energy and directs it down line 418 to photo detector 420. Photo detector 420 outputs an electronic signal on line 422 to low pass filter 424 that provides signal 66b to processor 70. Signal 66b is representative of the unmodulated (dc) portion of the photonic signal on lines 59 and 401. The major portion of the photonic energy entering coupler 416 on line 401 exits the compensator on line 46 as the photonic data signal.

The more detailed preferred embodiment of compensator 60 shown in FIG. 27 contains additional elements. The electronic output of photonic detector 404 travels on line 406 to rf preamplifier 426 where the signal is amplified and then output on line 428 to high pass filter 408. After passing through high-pass filter 408, the rf signal is passed on line 410 to amplifier 430, and then on line 432 to detector 412. Detector 412 detects the rf signal from line 432 and outputs the resultant signal on line 434 to low-pass filter 436. After passing through the low-pass filter 436, the signal goes out on line 66a to channel processor 70 as the signal representative of the modulated photonic power present on line 59.

The preferred embodiment of compensator 60 has an additional amplifier 437 to receive the signal on line 422 and output an amplified signal on line 438 to low pass filter 424. In FIG. 26 and FIG. 27, a photonic input enters on line 59, which is sampled and portions of the photonic signal are extracted from which two electronic signals are derived. A signal representative of the modulated photonic power on line 59 is output on line 66a. The electronic signal output on line 66b is a data signal representative of the average photonic power input on line 59. Coupler 400 serves to extract a small fraction of the total photonic data power passing in from line 59 and out through line 401. The photonic information passed to photo detector 404 on line 402 is converted to an rf signal, amplified by rf preamplifier 426, filtered by high pass filter 408 to eliminate the low frequency and totally unmodulated portions of the signal, amplified by amplifier 430, and detected by detector 412. The electronic information on line 434 is low-pass filtered by filter 436 which in some embodiments may be an anti-aliasing filter designed to prevent aliasing due to the discrete sampling frequency employed in interface 68 when an analog-to-digital (A/D) converter is employed when the processor 70 is digital. Filter 436 also serves to reduce noise in the system and improve the signal-to-noise-ratio (SNR). Other embodiments may employ analog processing, in which case filter 436 serves to reduce noise but is not required to perform an anti-aliasing function. Low pass filter 424 serves a similar function to filter 436, to reduce noise, improve the SNR in all embodiments and as an anti-aliasing filter when utilizing an embodiment involving digital processing.

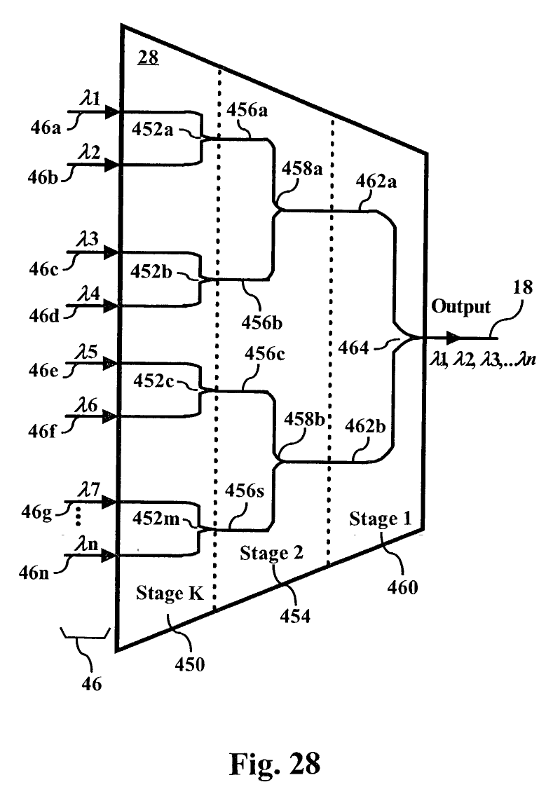

Referring to FIG. 28, specifically, and to FIGS. 28 through 32, generally, data signals 46 when they exit individual channel stabilizers 44, enter photonic multiplexer 28. Each channel stabilizer 44a, 44b, 44c, . . . 44n having its own separate line 46a, 46b, 46c, . . . 46n, respectively, to multiplexer 28. Each line 46a, 46b, 46c, . . . 46n, carries a photonic signal characterized by a distinct wavelength λ1, λ2, λ3, . . . λn, respectively. In one embodiment, multiplexer 28 is of the coupler type. Each input line 46 carries “n” photonic information signals into the kth stage of multiplexer 28 to couplers 452, at which stage the power amplitude of each signal is reduced, typically by half, as the total number of signal lines is reduced by half each time two signals are combined onto one line, i.e. multiplexed. Couplers 452, 458, and 463 are commonly designed to be 3 db couplers. The power level is split in half at each stage. After passing through coupler 452, the signal proceeds down line 456 to coupler 458 where the amplitude is reduced again by half. The output of coupler 458a proceeds down line 462a to coupler 464 where the amplitude is again divided by half before being output on line 18 as a multiplexed signal. For example line 46a carrying a data signal characterized by wavelength λ1 enters multiplexer 28 and goes into coupler junction 452a where it is combined with the signal from line 46b characterized by wavelength λ2. The combined signal containing information at wavelengths λ1 and λ2 goes down line 456a to coupler 458a where it is combined with the multiplexed signal on line 456b characterized by wavelengths λ3 and λ4. The multiplexed signal on line 462a characterized by wavelengths λ1, λ2, λ3, and λ4 enters coupler junction 464 where it is combined with other multiplexed signals coming in on line 462b and output on line 18 as a composite multiplexed signal characterized by the wavelengths λ1, λ2, λ3, . . . λn originally input on lines 46a, 46b, 46c, . . . 46n. The present multiplexer embodiment 28 has photonic data inputs 46 and multiple multiplexing stages 1, 2, . . . k, represented by 460, 454, and 450. Other stages may exist but are not explicitly shown in FIG. 28. Multiple stages are represented by stage K going down to stage 2, then to stage 1, and finally to a single output. The amplitudes of input signals 46 are reduced at each coupling stage so the embodiment of coupler multiplexer 28 shown in 28 is only practical for a limited number of stages because of losses.

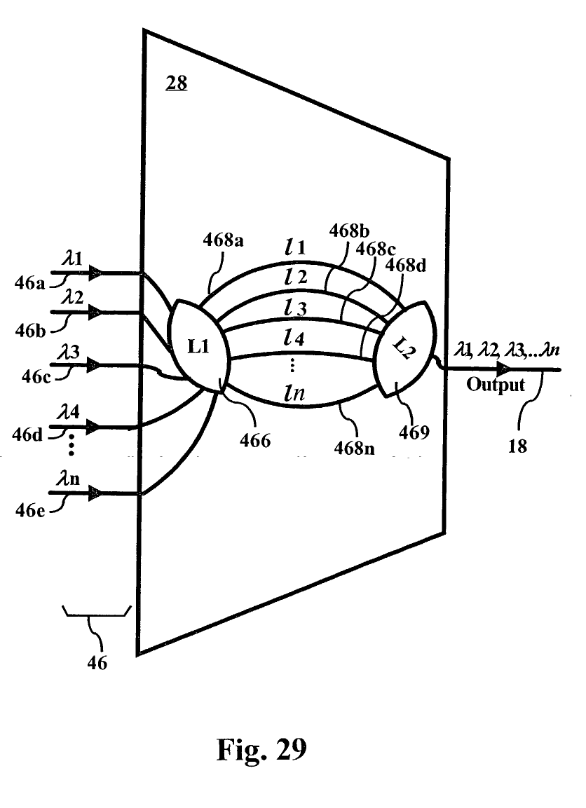

Referring to FIG. 29, photonic multiplexer 28 of the arrayed waveguide (AWG) type has photonic data inputs 46a, 46b, 46c, . . . 46n, carrying photonic signals characterized by distinct wavelengths λ1, λ2, λ3, . . . λn, respectively, each of which passes through lensing structure 466 to paths lengths 468a, 468b, 468c, 468d, . . . 468n, each of which is characterized by an effective photonic path length L1, L2, L3, . . . Ln. After traversing paths 468, each of which has a distinct length, the photonic signals enter lens structure 469, and are output through line 18 as a composite multiplexed signal, characterized by wavelengths λ1, λ2, λ3, . . . λn. The lens structures 466 and 469 shown are representative of what happens. The specific details of the structure and architecture used may vary, but the net effect is that photonic data input signals 46 go through a lens-like transformation 466, then through photonic path lengths which are each distinct, through another lens-like transformation 469, and are output on line 18. The distinct line lengths of paths 468 effect a phase shift of the photonic signals on each line and a multiplexing of the distinct wavelengths on output line 18. The structure is efficient. Photonic losses are generally low.

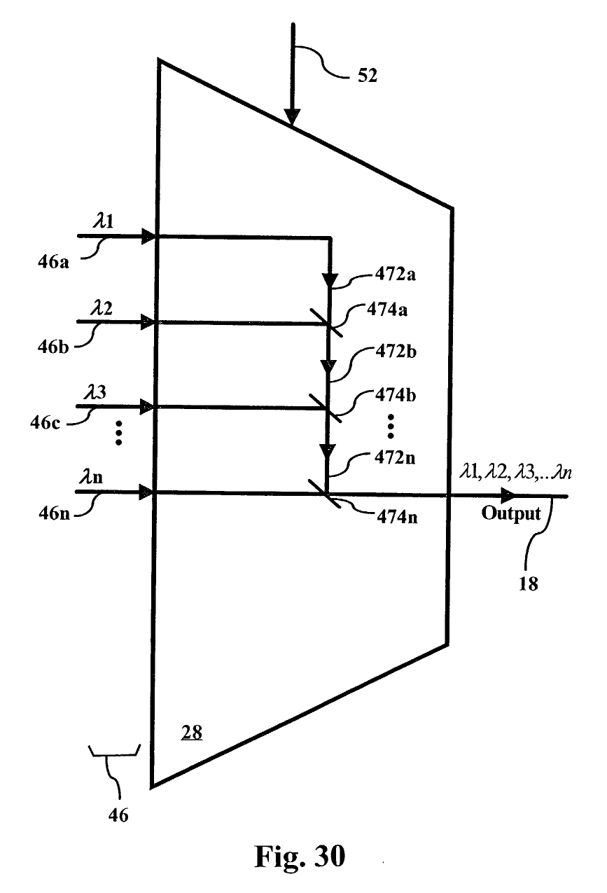

Referring to FIG. 30, multiplexer 28 of the dielectric type has photonic data inputs 46 through which photonic data signals are received, each characterized by a distinct wavelength λ1, λ2, λ3, . . . λn as discussed previously. The photonic data signal on line 46a characterized by wavelength λ1 enters dielectric multiplexer 28 and proceeds on line 472a to dielectric combiner 474a where it is combined with the signal coming in on line 46b characterized by λ2, and is output on line 472b. The composite photonic signal on line 472b characterized by wavelengths λ1 and λ2 passes to dielectric combiner 474b, where the signal from line 46c characterized by wavelength λ3 is added to the composite signal. The composite signal is passed down the line successively to line 472n and combines with the signal on line 46n characterized by wavelength λn at combiner surface 474n to produce the fully multiplexed signal characterized by wavelengths λ1, λ2, λ3, . . . λn output onto line 18.

Dielectric surfaces 474 may be any of the surface types: splitter, combiner, reflector, or a combination thereof. Dielectric surfaces 474 having one behavior type at a given wavelength may and often do have different behavior characteristics at different wavelengths. For example what constitutes a splitter or combiner at one wavelength may reflect at other wavelengths.

In an alternate embodiment local control lines 52 may be used to control the temperature and other characteristics of dielectric surfaces 474, or otherwise influence the wavelength selectivity of multiplexer 28 under the local control of master controller 30. Details of dielectric multiplexer 28 such as the geometrical layout may be considerably different from those illustrated in FIG. 30, but the principals of operation are similar. Dielectric splitters and combiners are used to combine photonic data signals having different wavelengths into one composite signal containing many wavelengths and many streams of multiplexed photonic data.

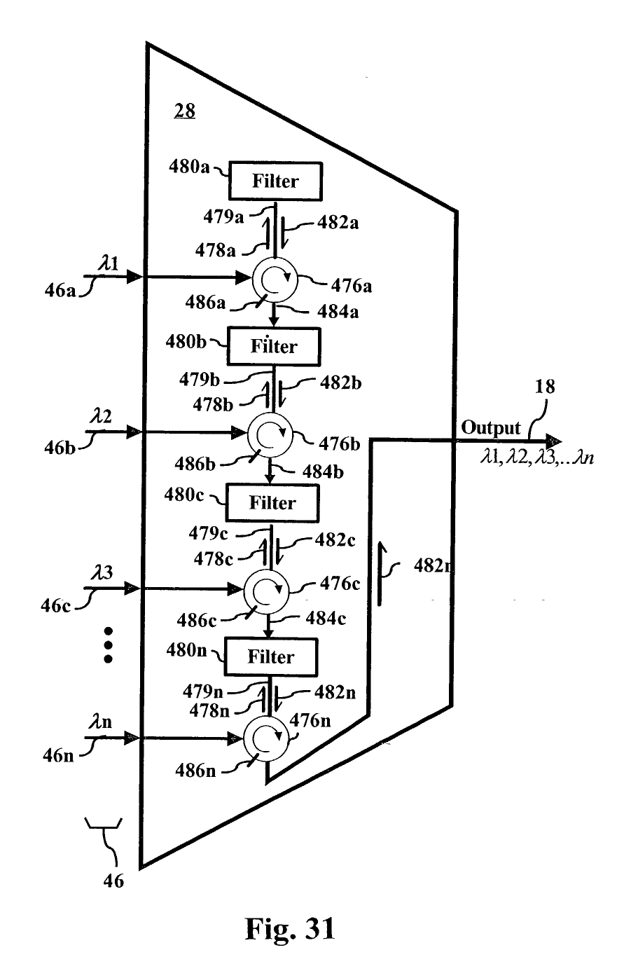

Referring to FIG. 31, multiplexer 28 of the circulator filter type has input data lines 46a, 46b, 46c, . . . 46n, prepared to receive photonic signals, each characterized by a distinct wavelength λ1, λ2, λ3, . . . λn, respectively, multiplexes all of the photonic input signals and outputs the composite result on line 18. The input signal on line 46a characterized by wavelength λ1 enters multiplexer 28 and first encounters circulator 476a which directs the photonic signal out line 479a as signal 478a to filter 480a. Filters 480 are narrow band reflection filters that reflect a narrow band of wavelengths surrounding the designed center wavelength and transmit all other wavelengths. Filter 480a reflects a narrow band of wavelengths centered around wavelength λ1 back to the source and transmits or absorbs all other wavelengths. Signal 482a feflected back by filter 480a onto line 479a is as narrow as or more narrow in bandwidth than the incident signal 478a. Signal 482a passes through circulator 476a and is output on line 484a to filter 480b which it passes through. The input signal on line 46b characterized by wavelength λ2 enters circulator 476b which directs the photonic signal out line 479b as signal 478b to filter 480b. Signal 478b is reflected back on line 479b and combined with signal 482a to become signal 482b which passes through circulator 476b to line 484b, through filter 480c to line 479c. The input signal on line 46c characterized by wavelength λ3 enters circulator 476c which directs the photonic signal out line 479c as signal 478c to filter 480c. Signal 478c is reflected back on line 479c and combined with signal 482b to become signal 482c which passes through circulator 476c to line 484c, and on down to till it passes through filter 480n to line 479n. The input signal on line 46n characterized by wavelength λn enters circulator 476n which directs the photonic signal out line 479 as signal 478n to the previous filter 480n−1 in the series. Signal 478n is reflected back from filter 480n−1 on line 479n and combined with signal 482n−1 to become signal 482n which passes through circulator 476n to output line 18 as the composite multiplexed photonic signal characterized by wavelengths λ1, λ2, λ3, . . . λn.

Input signals on lines 46 upon entering multiplexer 28 enter circulators 476, which pass the signals up on lines 479 as signals 478 to filters 480, which filters selectively reflect a narrow band of wavelengths centered around the selected channel wavelength for that specific line and transmit all others. The reflected narrow band signals 482 return on lines 479 to circulators 476 and are passed to the next output level of lines 479 successively until stage n is reached at which point the composite multiplexed signal is output on line 18. Each narrow band reflection filter 480 is constructed such that it reflects the respective wavelength for which it is designed and transmits all other wavelengths. For example, filter 480a reflects the wavelength λ1 coming in on line 46a, but transmits all other wavelengths through it. Filter 480b reflects wavelength λ2 coming in on line 46b and transmits all other wavelengths, bi-directionally. Filter 480c reflects wavelength λ3, coming in on line 46c but transmits all other wavelengths. Filter 480n reflects the wavelength λn, coming in on line 46n but transmits all other wavelengths. Information coming in on line 46a, if not narrow band initially, is narrowed by the filtering action of filter 480a. That is, filter 480a reflects a narrow band of frequencies. If the signal 46a characterized by wavelength λ1 has other information to either side of wavelength λ1, that information passes through filter 480a and is not reflected back down into the main data stream as part of signal 482a. Thus, information converges from line 46a, 46b, 46c, down through 46n onto the output line of circulator 476n, which is line 18 and output as a composite group of multiplexed wavelengths on the output line.

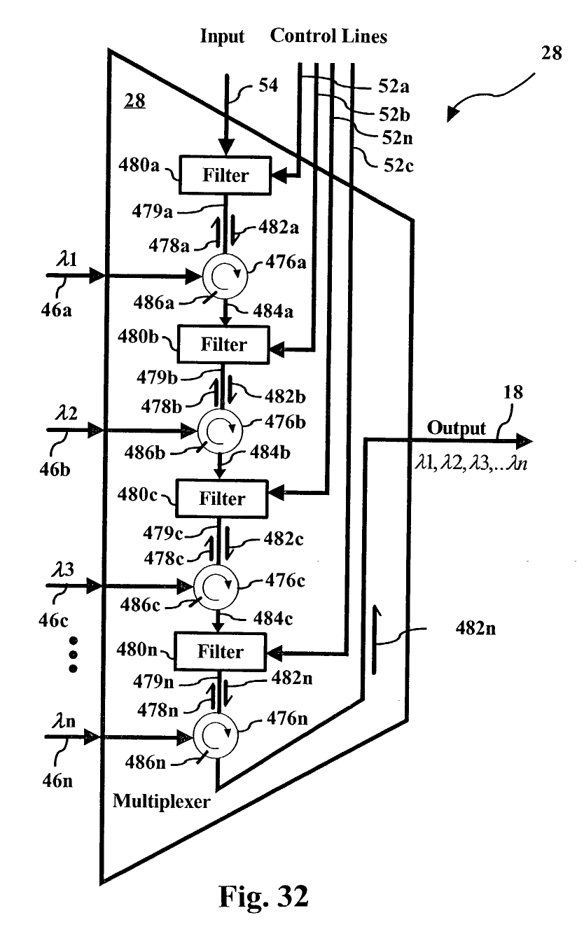

Referring to FIG. 32, multiplexer 28 of the circulator filter type receives data signals 46 which are each characterized by a unique wavelength (λ), which wavelengths after being filtered using the circulator filter combination are output on line 18. In an alternate embodiment, control lines 52 and 54, control filters 480 under direction of master controller 30. Additional control information of a photonic nature may be inserted through line 54 as part of the multiplexed output signal 18. Thus, local control exerted by control lines 52 can be exerted by changing the temperature or otherwise affecting the filter characteristics and properties by shifting the filter properties of the filters 480. Remote control can be exerted by inserting a photonic signal on line 54 which becomes part of the photonic information which is transmitted to the remote terminal at the other end of line 18. Thus, control can be exerted locally and remotely in the current embodiment by master controller 30.

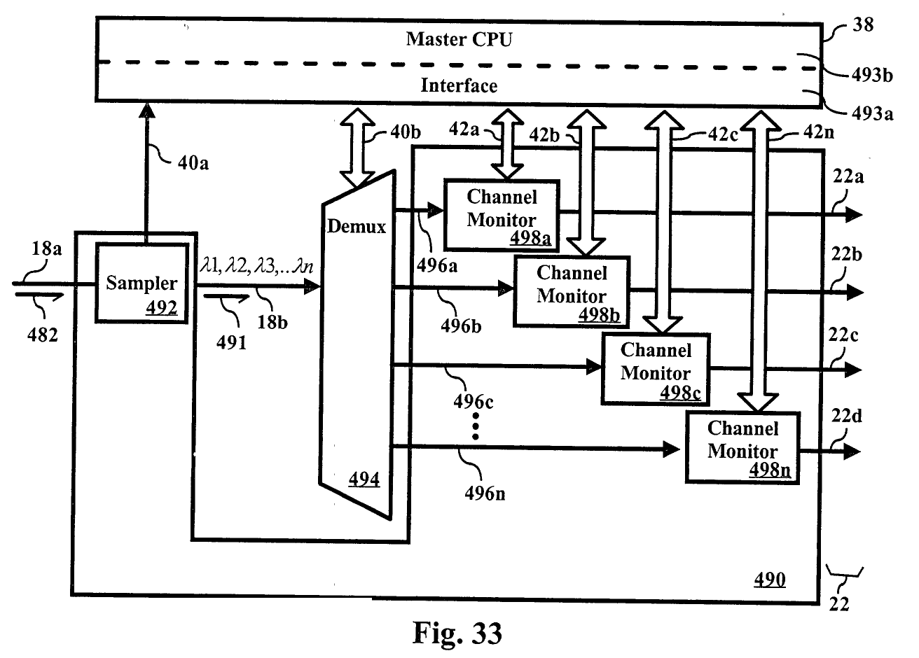

Referring to FIG. 33, specifically and to FIGS. 28 to 39 generally, multiplexer 28 transmits multiplexed photonic information over a connecting link 18, which may be a short distance or more commonly a longer distance of many kilometers to remote receiver 20. Photonic data 482 goes from sender 16 over intervening photonic link 18 to receiver 20. Receiver 20 receives multiplexed photonic data through line 18a. A small fraction of photonic signal 482 is coupled through coupler 492 and output through line 40a to master controller 38. The major portion of signal 482 is transmitted through coupler 492 as signal 491. Multiplexed signal 491 enters demultiplexer 494. The demultiplexer has control interface lines 40 in some embodiments for receiving and sending control information. Demultiplexer 494 demultiplexes photonic signal 491 into individual signals characterized by wavelengths λ1, λ2, λ3, . . . λn which are output on lines 496a, 496b, 496c through 496n, respectively. The total number of channels ‘n’ is a number determined for each system according to the needs of that system. Each output line 496 is characterized by a photonic signal of a specific wavelength λ.

After passing through demultiplexer 494 and being demultiplexed into distinct channels 496, the individual wavelength channels 496 are passed through to monitors 498. Each monitor 498 samples a fraction of the signal on its own incoming line 496 and communicates the information out port 42 to master controller 38. The vast majority of photonic signal power coming in on lines 496 out lines 22. Each channel monitor 498 is a part of the channel monitoring assembly 490. Each channel monitor 498 has a communications line or lines 42 with which to communicate with master controller 38 through an interface 493a to master CPU 493b.

Master controller 38 is composed of two parts, interface 493a and master processor 493b. Interface 493a is designed to receive signals from sampler 492, demultiplexer 494, and each channel monitor 498 and translate the information into a form suitable for the central processor 493b to accept and process. The interface receives control direction form master processor 493b and translates it into a form suitable for controlling hardware such as demultiplexer 494 and channel monitors 498.

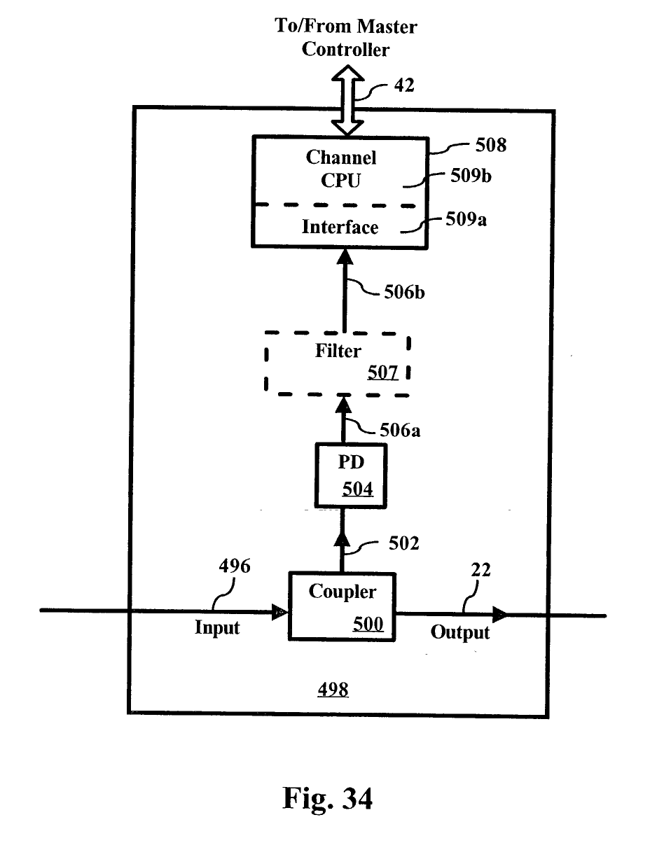

Referring to FIG. 34, one embodiment of a channel monitor 498 receives the demultiplexed photonic data signal 496 into coupler 500 where a small fraction is coupled out through line 502 to photo-detector 504. Photo-detector 504 outputs an electronic signal on line 506a which optionally may be filtered by filter 507 and is subsequently passed on line 506b to the channel processor 508. Channel processor 508 includes interface 509a to receive the signal on line 506b and the channel CPU 509b to process information. Channel processor 508 communicates with master controller 38 through lines 42 as needed. The major portion of the photonic data signal which enters on line 496 to coupler 500 exits out line 22 as the demultiplexed output having been sampled by coupler 500 for control and monitoring purposes.

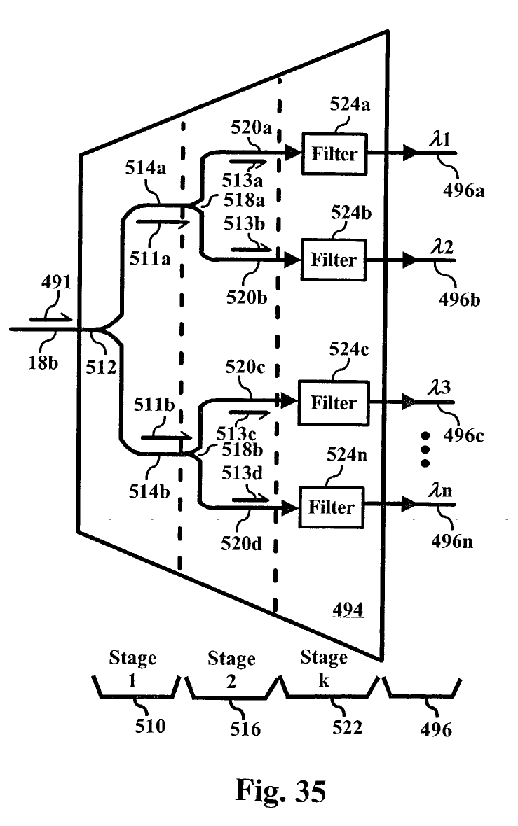

Referring to FIG. 35, demultiplexer 494 of the waveguide coupler type receives photonic data signal 491 on input line 18b. Signal 491 enters the first stage 510 of demultiplexer 494 and is split in amplitude by splitter junction 512. The splitting ratio is typically 50/50. Other splitting ratios may be used, as needed. Photonic data signal 491 entering on line 18b is split into two parts. Part of signal 491 goes on line 514a as signal 511a and part goes on line 514b as signal 511b. Line 514a passes to the second demultiplexer stage 516 and enters splitter junction 518a where signal 511a is split into parts 513a and 513b which parts proceed on lines 520a and 520b, respectively. Photonic data signal 513a goes on line 520a through subsequent demultiplexer stages containing splitter junctions and data lines until it enters the kth stage 522 and encounters filter 524a. Narrow-band filter 524a passes a narrow waverlength band characterized by λ1 and outputs that signal on line 496a. The remaining wavelengths being rejected, absorbed, or otherwise discarded on that particular line. Waveguide demultiplexers 494 of the waveguide splitter type consist of successive stages as shown in FIG. 35. The kth stage 522 may be a number of stages removed from stage two. At each successive stage, the power amplitude in the lines is ordinarily cut in half as it undergoes splitting Because of the reduction in photonic signal amplitude with each stage, only a limited number of stages are useful in practice. Demultiplexer 494 of the splitter type has use, or is typically useful only for a limited a number of stages because of the splitting losses which occur at every stage, which are typically 3 db or half power at each stage. The purpose of the filters 524 is to select a given narrow wavelength band for a given line. Filter 524a selects a narrow-band of wavelengths characterized by wavelength λ1, which is output on line 496a. Likewise, filter 524b selects a narrow-band of wavelengths characterized by wavelength λ2, which is output on line 496b. Thus, each filter selects a narrow-band of wavelengths to output on a given line and thus distinguishes the channels one from another with the remaining unused light being unused.

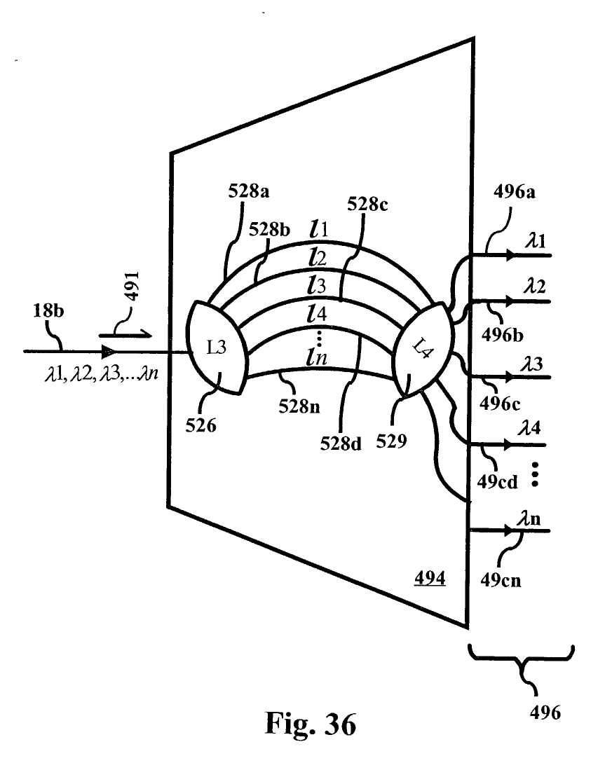

Referring to FIG. 36, demultiplexer 494 of the AWG type has photonic input line 18b over which multiplexed photonic signal 491 is received. Photonic signal 491 consists of multiplexed data signals characterized by wavelengths λ1, λ2, λ3, . . . λn. Signal 491 enters demultiplexer 494 and encounters lens 526 which splits the incoming multiplexed signal into fractional amplitude parts and sends them down paths 528a, 528b, 528c, . . . 528n, each characterized by a distinct photonic path length and a coincident phase delay. After traversing the distinct paths 528a, 528b, 528c, 528d, . . . 528n, the photonic signals enter lens 529 where the combination of lenses 526 and 529 with the distinct photonic path lengths 528, results in a separating of the channels by wavelength onto lines 496. The narrow-band photonic signal characterized by wavelength λ1 is output on line 496a. The narrow-band photonic signal characterized by wavelength λ2 is output on line 496b. The narrow-band photonic signal characterized by wavelength λ3, is output on line 496c. And so forth until the narrow-band photonic signal characterized by wavelength λn is output on line 496n. The multiplexed photonic signal input on line 18 carrying a number of distinct wavelengths multiplexed together is separated and output on distinct lines 496a, 486b, 496c, . . . 496n. The illustration given in FIG. 36 is a representation of what actually happens. Alternate embodiments of demultiplexer 494 of the AWG type exist. The lensing effect shown using lenses 526 and 529 is one representation of what occurs. The actual physical AWG demultiplexer embodiment 494 may involve a physical structure which looks different but has the same functionality as a set of lenses with a set of intervening photonic paths each having a distinct length used to separate wavelengths into bands characterized by a set of wavelengths λ1, λ2, λ3, . . . λn and output the resultant signals onto photonic paths 496.

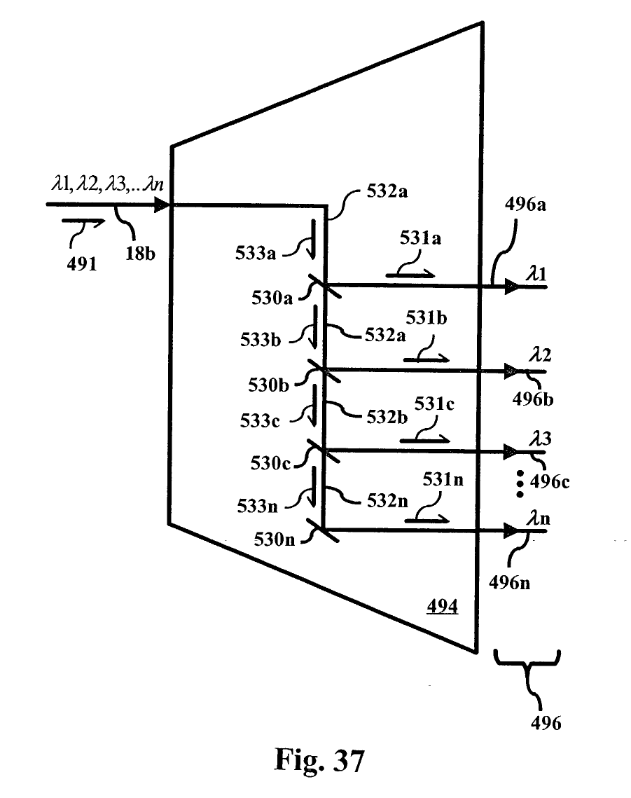

Referring to FIG. 37, demultiplexer 494 of the dielectric type receives signal 491 carrying multiplexed photonic data on input line 18b which becomes line 532a. Signal 491 enters demultiplexer 494 and becomes signal 533a. Signal 533a travels on line 532a to dielectric 530a which reflectively splits off signal 531a characterized by wavelength λ1 and directs it out line 496a. The remainder of signal 533a transmitted by dielectric 530a becomes signal 533b on line 532b. Signal 533b travels on line 532b to dielectric 530b which reflectively splits off signal 531b characterized by wavelength λ2 and directs it out line 496b. The remainder of signal 533b transmitted by dielectric 530b becomes signal 533c on line 532c. Signal 533c travels on line 532c to dielectric 530c which reflectively splits off signal 531c characterized by wavelength λ3 and directs it out line 496c. The remainder of signal 533c transmitted by dielectric 530c passes successively through dielectric splitters 530 until it becomes signal 533n on line 532n. Signal 533n travels on line 532n to dielectric 530n, which reflectively splits off signal 531n, characterized by wavelength λn and directs it out line 496n. The remainder of signal 533n transmitted by dielectric 530n becomes waste light when it is not used for monitoring or control.

Wavelengths entering on line 18b encounter dielectric surfaces 530 and one at a time the bands are output on lines 496. In viewing the physical layout of the dielectric surfaces, it should be recognized that the physical layout shown is not necessarily identical with the layout used in practice. The key concept is that dielectric layers are used to selectively transmit or reflect selected wavelength bands of a narrow-band type and in some instances of a broad-band type such that an incoming multiplexed signal 18b is subdivided into narrow bands of wavelengths for output on lines 496. Alternate embodiments utilizing the concept of reflective and transmissive dielectric surfaces exist.

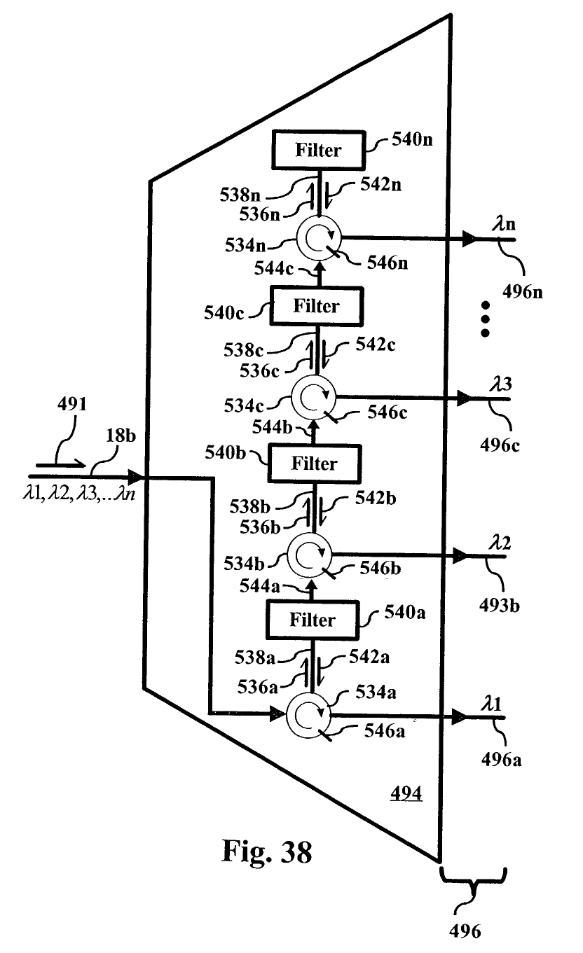

Referring to FIG. 38, demultiplexer 494 of the circulator filter type receives signal 491 on incoming line 18b. The multiplexed photonic signal enters circulator 534a and is directed out line 538a as signal 536a to filter 540a. Filters 540 selectively reflect a very narrow-band of wavelengths and transmit a broadband of wavelengths. When signal 536a encounters filter 540a, a very narrow-band of wavelengths, characterized by wavelength λ1, is reflected by filter 540a as signal 542a back to circulator 534a where the circulator directs signal 542a out path 496a as a very narrow-band of wavelengths characterized by wavelength λ1. Any signals coming in on line 496 are absorbed by stop 546 of circulator 534. The non-reflected remainder of signal 536a is transmitted by filter 540a onto line 544a to circulator 534b. Circulator 534b directs the signal as photonic signal 536b up line 538b to filter 540b which directs it out line 538b. A very narrow-band of wavelengths, characterized by wavelength λ2 is reflected as signal 542b on line 538b to circulator 534b and subsequently out on line 496b as a narrow-band of photonic wavelengths, characterized by wavelength λ2. The wavelength-band reflection and separation process is repeated at each successive filter stage for each successive wavelength λ1, λ2, λ3, . . . λn. Filters 540a, 540b, 540c, . . . 540n output distinct wavelength bands, by design. Each of the filters 540 is designed to reflect a single very narrow-band of wavelengths characterized by one of the distinct wavelengths, λ1, λ2, λ3, . . . λn, resulting in wavelength-selected output on lines 496a, 496b, 496c, . . . 496n, respectively. Demultiplexer 494 is designed such that a multiplexed, photonic data signal 491 is input on line 18b, encounters a combination of circulators and filters of selective types such that the input signal 18b is separated into very narrow wavelength bands characterized by distinct wavelengths and output on lines 496.

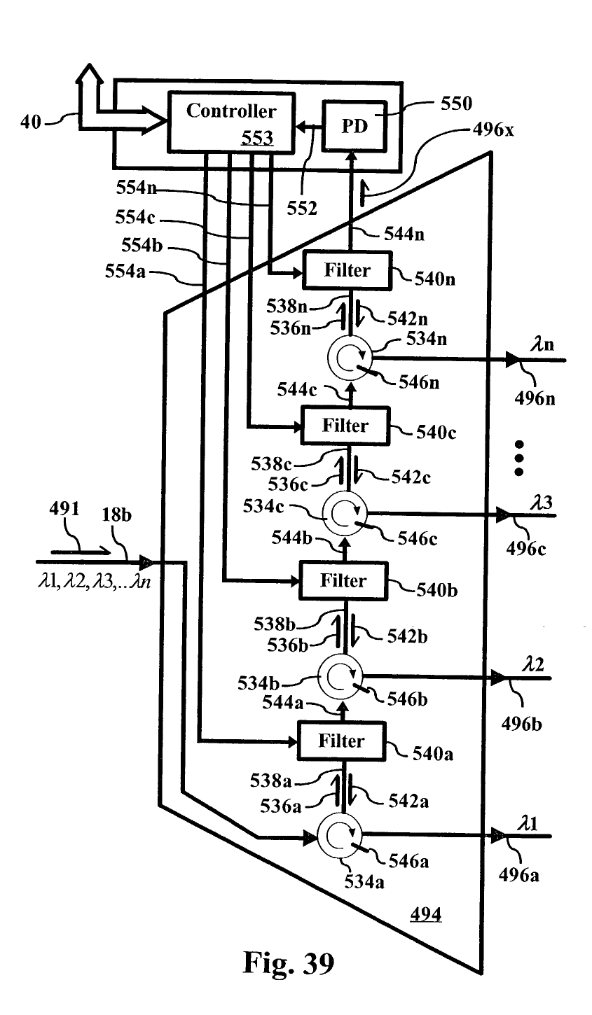

Referring to FIG. 39, in one embodiment of demultiplexer 494 of the circulator filter type received signal 491 on line 18b may have one or more photonic channels dedicated to control information from the sending apparatus 16. Such control channel wavelengths may be selected from existing photonic channels or may be in addition thereto. Signal 496x exits filter 540n as the photonic transmitted control signal portion of input signal 491 and enters photo detector 550. Detector 550 provides an electronic signal on path 552 to controller 553. Controller 553 receives the control information on line 552 and in conjunction with control information delivered through lines 40 from master controller 38 may direct filters 540 through lines 554. The embodiment shown in FIG. 39 shows only one photonic control signal 496x and one photo detector 550. Alternative embodiments may employ multiple photonic control lines 496x, multiple detectors 550, and multiple control data lines 552, in addition to the multiple filter control lines 554. Demultiplexer embodiment 494 shown in FIG. 39 has photonic control line 496x as the last photonic signal extracted from multiplexed signal 491 for convenience of illustration. Alternate embodiments may use any of the photonic signals 496 for transferring control information and exercising control remotely. By sampling output signal λ on line 496x channel controller 553 in concert with master controller 38 can exert wavelength control over filters 540 to change wavelengths as needed for fine tuning purposes, for maintaining stability or for other adaptive purposes as photonic signal direction to the outputs 496 as desired. One embodiment of multiplexer 28 may be used to multiplex a photonic data signal output on line 18, whereas a different embodiment of demultiplexer 494 may be used in the demultiplexing process. The multiplexer and demultiplexer need not be of the same type but may be varied according to needs, cost, performance requirements, and other such matters. The embodiments shown for multiplexers 28 and demultiplexers 494 are not the only types possible. Other types are in existence and are usable such as Eschelle gratings, prisms, and other grating oriented devices. The embodiments shown for multiplexers 28 and demultiplexers 494 may be used interchangeably. Control may be exerted on the multiplexer end or on the demultiplexer end to control or influence output wavelengths, output paths, stabilization, and other desirable parameters. Adjustable parameters may be fixed and not variable in some embodiments employed.

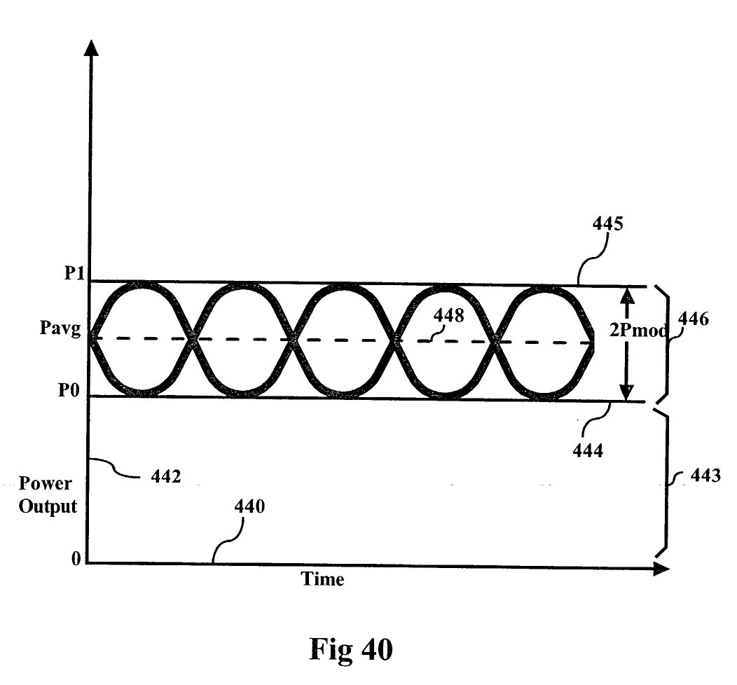

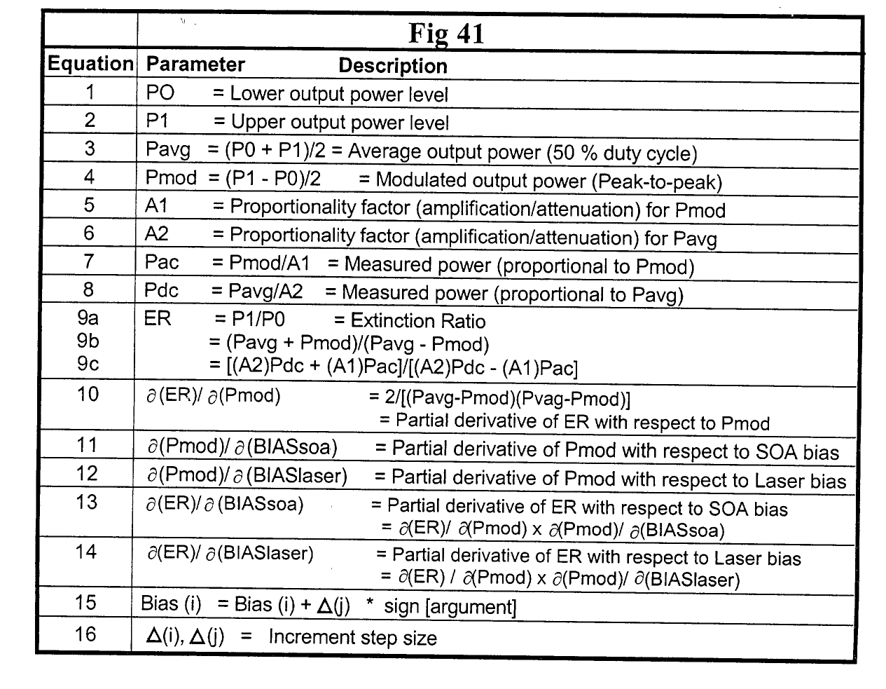

Referring to FIGS. 40 and 41, specifically, while referring generally to FIGS. 4 through 39, a photonic data signal present on a single channel such as would be found on lines 46 and 59, examples of which are 93, 128c, 199, 214 and 288, is typically composed of two parts. An unmodulated part referred to as the DC portion and a modulated part, referred to as the AC or the modulated portion of the photonic data signal. A representation of such a photonic data signal folded onto itself to form an “eye diagram” is shown in FIG. 40. The horizontal axis is the “time” axis 440 and represents time, increasing to the right. The vertical axis is the “power” axis 442 and represents photonic power output increasing going up. In this instance it is relative power output, the exact amplitude is not of specific concern, but the relative powers are. The unmodulated or DC photonic signal power level 443 is marked by upper level 444. Twice the value of the modulated (Pmod) or AC photonic power level 446 is encompassed between the lower power level 444 and the upper power level 445. Pmod is one half of the difference between the lower-bound 444, designated P0, the upper-bound 445, designated P1. The average of the sum of photonic power levels 444 and 445 is designated as Pavg 448. The average photonic power level 448 will be exactly halfway between the lower power level 444, designated by P0 and the upper power level 445, designated by P1 only when the photonic data signal is modulated symmetrically. A parameter of interest described as the extinction ratio (ER) can be defined as the upper power level 445 (P1), divided by the lower power level 444 (P0). ER is P1 over P0, using the parameters illustrated in FIG. 40 and defined in FIG. 41. It is generally considered desirable to have a large ER. It is desirable to have photonic power amplitude 446 be large, relative to photonic power amplitude 443. Stated in other words, for photonic data signals, it is desirable to have a large AC photonic power 446 and a relatively small DC photonic power 443. In the given embodiment for measuring the photonic power output shown in FIG. 26 and FIG. 27, the AC photonic data power and the DC photonic data power or a signal proportional thereto are measured as signals 66a and 66b, respectively. The photonic AC signal 66a is related to the modulated photonic power by a proportionality factor A1 as shown in equation 7 of FIG. 41. The measured DC photonic power 66b is related to the average photonic power by a proportionality constant A2, as shown in equation 8 of FIG. 41. Pmod and Pavg are not measured explicitly, but power levels proportional thereto are measured and satisfactory for present purposes. Changes in ER relative to changes in the modulated power output, as designated in equation 10 can be calculated or measured empirically using perturbational techniques. Parameter variations relative to changes in other parameters can be measured or ascertained using measured data, as shown in equations 11 through 15 of FIG. 41. For example, referring to FIG. 9; changes in Pmod and ER measured on line 59 relative to changes in the bias of nonlinear gain elements such as nonlinear media 90b can be derived. In some embodiments nonlinear media 90b may be an SOA. Change in Pmod relative to biasing of a reference laser 124 can also be calculated. Changes in ER relative to bias levels of nonlinear media 90b can be calculated. Changes in ER relative to changes in the bias level of reference laser 124 can also be calculated or be determined otherwise from perturbational or empirical means.

In summary, variations in parameters of interest such as ER and the Pmod, relative to changes in other parameters or other physically measurable quantities, Pac, Pdc, the bias on nonlinear media, the bias on a reference laser, can be determined either by calculation or perturbational measurements. Perturbational measurements have the advantage that less calculation is necessary. By simply measuring a primary parameter of interest, such as ER, Pmod, or Pavg, and then by perturbing a secondary parameter, such as the bias level on a nonlinear media element, the bias level on a laser, or the power level of another parameter which in some way affects the parameters of interest, variational relationships can be determined. Parameter variations may be completed in either a primary manner or in a secondary manner such as varying temperature, refractive index or other such secondary parameters.

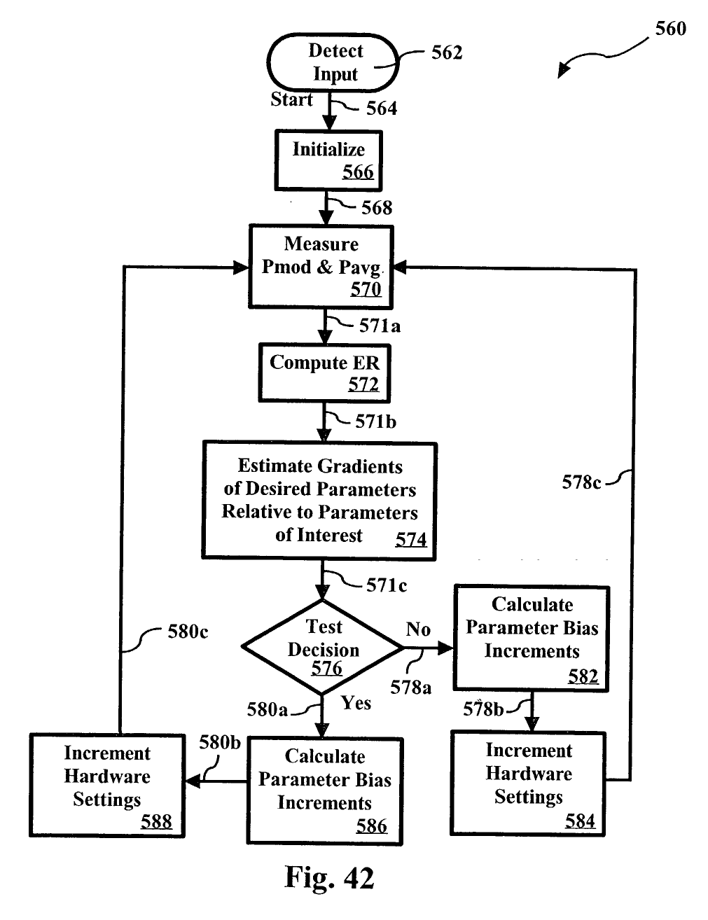

Referring to FIG. 42, one embodiment of control method and architecture for optimization process 560 of the performance of channel stabilizers 44 and data stabilizers 58 begins with input detection 562. Input detection 562 is used to determine if photonic data is present on incoming data line 14. The control methodology for optimizing a parameter of interest such as ER or Pmod begins with the detection step 562 at which the presence or absence of a photonic signal carrying data is detected by sampling the incoming photonic data line using a coupler and detector. Only a very low-level signal sample is needed in the detection process. After data is determined to be present by detection apparatus 562, the START command is given on path 564 and INITIALIZATION 566 begins. A first stage of initialization involves the master controllers and individual channel processors each determining that relevant equipment is turned on and fully functional within the pre-determined operating specifications. At sender 16 master controller 30 and channel processors 70 may be involved, while at receiver 20 master controller 38 and channel processors 508 may be involved. At a given physical location, master controller 30 for sender 16 and master controller 38 for receiver 20 at that location may be the same device. At a given location, channel processors 70 for sender 16 and channel processors 508 for receiver 20 may be the same device. This does not imply that a sender is sending to itself, but to the contrary, each location may have both a sender and a receiver, which share processors. A second stage of initialization involves “setting” the threshold levels for some independent operational parameters, and optimizing the remaining parameters. In one embodiment a threshold level for Pmod may be set initially and subsequently used in the optimization decision-making process. For example, some channel stabilizer embodiments may have five independent operational parameters where three are “fixed” at desirable operation points and the remaining two are optimized. Other embodiments may only have three independent parameters of interest where one is “fixed” and two are optimized. Additional parameters may be optimized, if necessary. Optimization of several carefully selected parameters with the remaining parameters “fixed” at desirable operating points may simplify the optimization process, while still providing the desired modulated output power levels, and the like. After initialization step 566 the main process is entered as indicated by path 568 to measurement step 570. At step 570 parameters are measured which are indicative of the photonic Pmod and Pavg. The first step in ongoing optimization process 570 is measuring the modulated and average photonic output powers followed in sequence 571a by the computation of extinction ratio 572. ER determination is followed by path 571b to step 574 where gradients of parameters such as ER, Pmod, and Pavg, relative to other operational parameters of interest are determined. Following gradient determination step 574 path 571c is taken to decision step 576 at which point a determination is made as to whether the measured and estimated parameters are at their desired operating points. If the chosen parameters do not meet the decision criteria then path 578 is taken to step 582 wherein the extent and direction of parameter changes to be implemented is determined. After parameter change step size is ascertained path 578b is taken to step 584 wherein the actual hardware settings are made and in succession path 578c is taken to step 570 to make new measurements of system parameters and dependencies.

When the parameters tested in step 576 meet the required criteria, path 580a is taken to step 586 wherein the extent and direction of parameter changes to be implemented is determined. The algorithmic details and correction procedure used in step 582 need not be closely related to the algorithmic details and correction procedure used in step 586. Parameters adjusted, step sizes used, and other details may be distinct for step 582 relative to step 586. The process continues on path 580b to step 588 involving incrementing hardware settings. The control process proceeds back through line 580c to step 570 where measurements are repeated, and the next self-correcting iteration begins. This process continues in an ongoing self-calibrating manner while the system is in operation. Other measures not delineated in detail include storing the last settings when power shut down occurs such that re-initialization time is shortened and stable desirable operation points are maintained the next time the system is turned on. Diagnostics are used to determine abnormal performance such as equipment failure or performance outside of required specifications so that corrections and system supervisor notification can be performed.

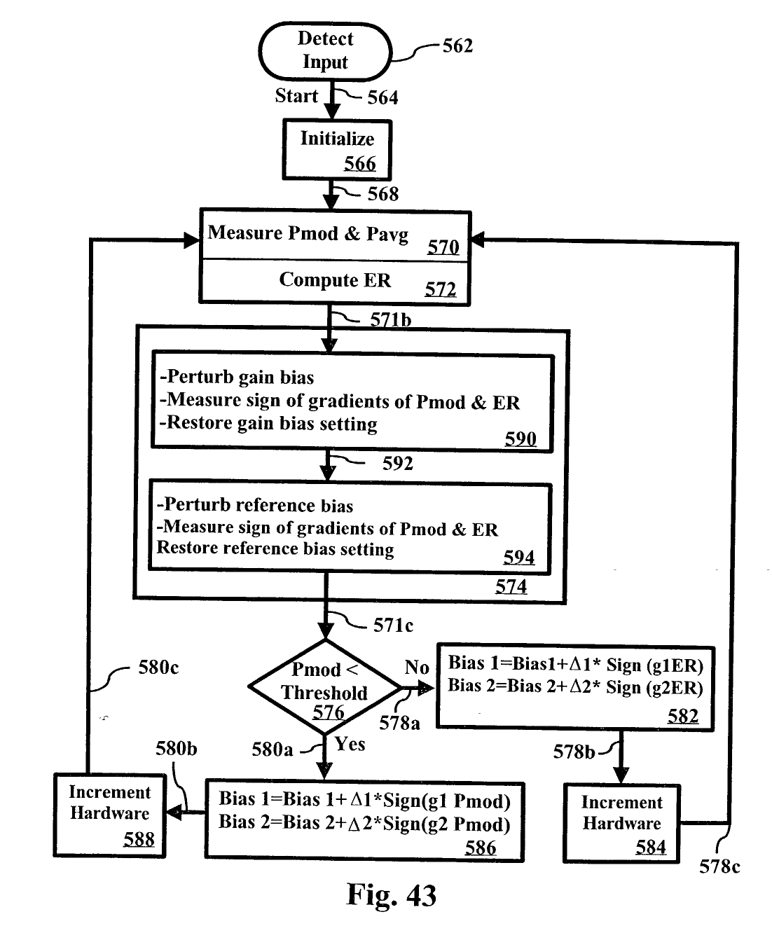

Referring to FIG. 43, specifically, while continuing to refer to FIGS. 42 and 43, generally, additional detail of one embodiment of optimization process 560 involves step 574 and perturbational determination of parameter values and sensitivities in two successive steps 590 and 594. Step 590 involves perturbing the gain bias of control media 78 of power stabilizing apparatus 56, measuring the sign of the gradients of Pmod and ER, restoring the gain bias of control media 78 to its previous setting if the sign is negative, and continuing the process on path 592 to the next step of perturbational measurements 594. The gradients of Pmod and ER in the present embodiment are with respect to reference laser bias levels and SOA bias levels. In alternate embodiments, gradients may be taken with respect to any parameter that is both adjustable and has some influence on either Pmod or ER. Step 594 involves perturbing the reference bias of data stabilizer 58, measuring the sign changes of the gradients of Pmod and ER, restoring the reference bias of 58 to its previous setting, and continuing the process on path 571c.

The procedure follows path 571c wherein a path decision or test is made. The test applied in this case is; Is Pmod less than the threshold level? If the answer is yes, then a parameter bias increment is calculated using the general formula given in FIG. 41, equation 15. Specific details of bias determination are given in step 586. Bias number 1 is calculated to be the old bias number 1 level plus a Δ1 increment multiplied by the sign of the first gradient of Pmod. Increments Δ1 and Δ2 are step-size increments that determine the magnitude of a given setting change. The increments in one embodiment are fixed, but additional optimization flexibility is enabled in alternate embodiments having step-sizes determined using an adaptive step-size. The new bias level 2 is calculated to be equal to the former bias level 2 plus a Δ2 increment multiplied by the sign of the second gradient of Pmod. The first gradient is calculated according to equation 11 and the second gradient is calculated according to equation 12 shown in FIG. 41. Criteria for choosing the size of increments Δ1 and Δ2 include (a) being sufficiently small so that overshoot does not occur during the optimization search process, yet (b) sufficiently large that convergence proceeds at a reasonable rate. Since the parameter space being optimized is unimodal, smooth, and well-behaved, considerable latitude exists in the choice of increment sizes. In practice, using a larger fixed step size results in more rapid convergence, but noisier steady state parameter values and hence noisier ER and Pmod. In a preferred embodiment the increment sizes are kept small, as parameter variations are not rapid, especially after completion of the system initialization process, and small perturbations on output power are desired. After gradients are calculated, path 580b is taken and hardware settings are incremented in step 588. When Pmod is not less than the threshold, the decision criteria 576 is not met, and path 578a is taken to step 582. The new bias level 1 is set equal to the old bias level 1, plus a Δ1 increment multiplied by the sign of gradient 1 of ER defined in equation 13 of FIG. 41. New bias level 2 is set equal to old bias level 2, plus a Δ2 increment multiplied by the sign of gradient 2 of ER. Gradient 2 of ER is as defined in equation 14 of FIG. 41. After bias levels are calculated in step 582, the system proceeds along step 578b to increment the hardware settings in step 584. Upon completion of incrementing the hardware, path 578c is taken to step 570, and the measurement process is begun again. The goal of the present embodiment is to set Pmod at a desirable acceptable level and then maximize ER. When ER increases Pmod decreases in the present embodiment. A control architecture capitalizing upon and exploiting the dependent relationship of ER and Pmod to obtain a desired performance objective does not exist in the prior art.

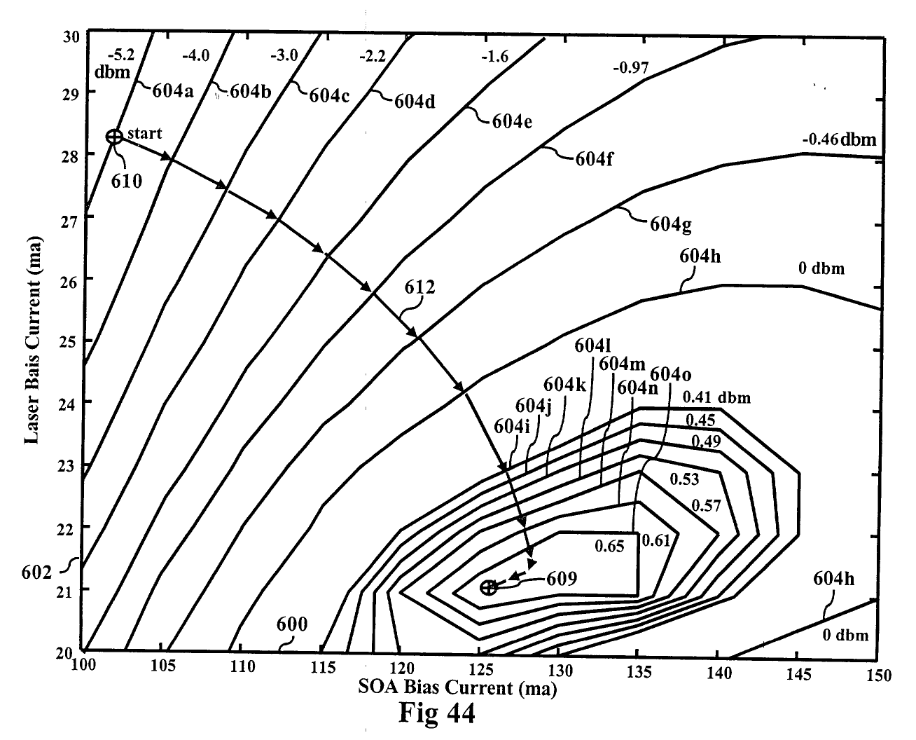

Referring to FIG. 44, specifically, while referring to FIGS. 41-44 generally, an illustration of a two parameter optimization search procedure involves varying an SOA bias current and a laser bias current as shown on graph axes 600 and 602, respectively, in order to maximize the photonic modulated output power of data stabilizer 58. Curves of constant photonic modulated output power 604 apply to the specific data stabilizer hardware 58 employed. Photonic output power is given in “dbm”, that is decibels of power relative to one milliwatt. Curves 604a-604o illustrate representative discrete modulated output power levels. The curves of constant modulated output power 604 are representative of the parameter space being searched, and do not necessarily change as abruptly as depicted. Optimization search process 560 begins at point 610, proceeds along optimization path 612, to the quasi-optimal ending point 609. The exact optimum final operation point is not required. A quasi-optimum point near the optimal solution is acceptable, as the optimization space is reasonably smooth and well-behaved.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A data stabilizer for use in an interferometric wavelength shifting apparatus comprising:
a power stabilizer having an input for receiving an input signal, and an output;
a reference source providing a reference signal;
a nonlinear media having an input and an output, said input operably connected to a combination of said output of said power stabilizer and a fraction of said reference signal and said output of said nonlinear media provides a modulated data signal;
a photonic path having a length and operably connected to said reference source to receive a remaining portion of said reference signal;
an interferometric junction operably connected to said output of said nonlinear media to receive said modulated data signal and to said photonic path to receive said remaining portion of said reference signal wherein said modulated data signal and said portion of said reference signal interferometrically couple to provide a stabilized data signal.

2. The a data stabilizer of claim 1, wherein said reference source, nonlinear media and interferometric junction determine an optical path-length, and wherein said length of said photonic path is different than said optical path-length.

3. The data stabilizer of claim 2 wherein said length of said photonic path is greater than said optical path-length.

4. The data stabilizer of claim 2, wherein said length of said photonic path is less than said optical path-length.

5. The data stabilizer of claim 1 wherein said reference source is a tunable laser.

6. The data stabilizer of claim 1 wherein said nonlinear media is a semiconductor optical amplifier.

7. The data stabilizer of claim 1 wherein said combination of said reference source, nonlinear media, and interferometric junction form a mach-zender interferometer.

8. The data stabilizer of claim 1 wherein said fraction of said reference signal is less than one half.

9. The data stabilizer of claim 1 wherein said modulated data signal has a first power level, and wherein said remaining portion of said reference signal has a second power level, and wherein said first and said second power levels are substantially equal.

10. The data stabilizer of claim 1 wherein said fraction of said reference signal is greater than one half.

11. The data stabilizer of claim 1 where said data stabilizer is co-propagating.

12. The data stabilizer of claim 1 where said data stabilizer is counter-propagating.

13. The data stabilizer of claim 1 further comprising a means for controlling said reference source.

14. The data stabilizer of claim 13 wherein said means for controlling said reference source comprises a means for tuning said reference source.

15. The data stabilizer of claim 1 further comprising a means for controlling said power stabilizer.

16. The data stabilizer of claim 1 further comprising a means for controlling said nonlinear media.

17. The data stabilizer of claim 1 wherein said input signal has a first wavelength, and said reference signal has a second wavelength, and wherein said first wavelength and said second wavelength are different.

18. The data stabilizer of claim 1 wherein said reference signal has a power level, said data stabilizer further comprises a means for adjusting said power level.

19. The data stabilizer of claim 1 wherein said modulated data signal has a first phase, and said remaining portion of said reference signal has a second phase, and wherein said first phase and said second phase are phase matched.

20. The data stabilizer of claim 1 wherein said stabilized data signal has a signal quality, said data stabilizer further comprising:
a means for dynamically measuring selected photonic signal parameters; and
a means for self-calibration of said signal quality, responsive to said selected photonic signal parameters.

21. The data stabilizer of claim 1 wherein said stabilized data signal has a signal quality, said data stabilizer further comprising:
a means for dynamically measuring selected photonic signal parameters; and
a means for optimizing said signal quality.
